(19) United States
(12) Patent Application Publication
(10) Pub. No.: US 2014/0207385 A1
(43) Pub. Date: Jul. 24, 2014

(54) SYSTEMS AND METHODS FOR CHARACTERIZING TOPOLOGICAL NETWORK PERTURBATIONS

(71) Applicants: Florian Martin, Peseux (CH); Alain Sewer, Orbe (CH)

(72) Inventors: Florian Martin, Peseux (CH); Alain Sewer, Orbe (CH)

(73) Assignee: PHILIP MORRIS PRODUCTS SA, 2000 Neuchâtel (CH)

(21) Appl. No.: 14/240,991

(22) PCT Filed: Feb. 24, 2012
(86) PCT No.: PCT/EP2012/066557

§ 371 Date: Mar. 4, 2014

Related U.S. Application Data
(60) Provisional application No. 61/527,946, filed on Aug. 26, 2011.

(51) Int. Cl. G06F 19/10

(52) U.S. Cl. CPC G06F 19/10
USPC 702/19

(57) ABSTRACT

Systems, computerized methods and products are disclosed herein for determining metrics for nodes in a network model of a biological system. Such systems and computerized methods can be used to quantify the response of a biological system to one or more perturbations based on measured activity data of a subset of entities in the biological system. Based on the activity data and a network model of the biological system, centrality values representative of the relative importance of a node in the network are derived. The centrality values are used for characterizing topological perturbations in the network, such as for performing sensitivity analysis, visualizing topological effects of a perturbation in the biological system, or deriving a score quantifying the response of the biological system to a perturbation such as exposure to a chemical agent.

### BACKGROUND

The human body is constantly perturbed by exposure to potentially harmful agents that can pose severe health risks in the long-term. Exposure to these agents can compromise the normal functioning of biological mechanisms internal to the human body. To understand and quantify the effect that these perturbations have on the human body, researchers study the mechanism by which biological systems respond to exposure to agents. Some groups have extensively utilized in vivo animal testing methods, but there is doubt as to whether responses obtained from animal testing may be extrapolated to human biology. Other methods include assessing risk through clinical studies of human volunteers. But these risk assessments are performed a posteriori and, because diseases may take decades to manifest, these assessments may not be sufficient to elucidate mechanisms that link harmful substances to disease. Yet other methods include in vitro experiments. Although, in vitro cell and tissue-based methods have received general acceptance as full or partial replacement methods for their animal-based counterparts, these methods have limited value. Because in vitro methods are focused on specific aspects of cells and tissues mechanisms; they do not always take into account the complex interactions that occur in the overall biological system.

In the last decade, high-throughput measurements of nucleic acid, protein and metabolite levels in conjunction with traditional dose-dependent efficacy and toxicity assays, have emerged as a means for elucidating mechanisms of action of many biological processes. Researchers have attempted to combine information from these disparate measurements with knowledge about biological pathways from the scientific literature to assemble meaningful biological models. To this end, researchers have begun using mathematical and computational techniques that can mine large quantities of data, such as clustering and statistical methods, to identify possible biological mechanisms of action.

Previous work has explored the possibility of finding a characteristic signature of gene expression changes that results from one or more perturbations to a biological process, and the subsequent scoring of the presence of that signature in additional data sets. Most work in this regard has involved identifying and scoring signatures that are correlated with a disease phenotype. These phenotype-derived signatures provide significant classification power, but lack a mechanistic or causal relationship between a single specific perturbation and the signature. Consequently, these signatures may represent multiple distinct unknown perturbations that, by often unknown mechanism(s), lead to, or result from, the same disease phenotype.

One challenge lies in understanding how the activities of various individual biological entities in a biological system enable the activation or suppression of different biological mechanisms. Because an individual entity, such as a gene, may be involved in multiple biological processes (e.g., inflammation and cell proliferation), measurement of the activity of the gene is not sufficient to identify the underlying biological process that triggers the activity.

Random walk methods have been used in network analysis to characterize network topology, for example, Komurov et al. (PLoS Computational Biology, August 2010, 6(8): e1000889) have described a method in which a data-biased random walk is defined and compared to a simple random walk. However, the Komurov approach assumes that each node has associated data and the network is undirected, but no probabilistic result is offered, and no sensitivity analysis is available. In addition, when using causal network models, not all entities (represented as nodes in the model) can be linked to experimental evidence. Moreover, when specific experimental data are gathered, the network will likely be unequally perturbed due to the specific mechanisms activated by the experiment. In view of the foregoing, there is in this field of computational biology a continuing need of more evolved and better methods for analyzing high throughput datasets in biomolecular network models.

### SUMMARY

Described herein are systems, methods, and products for quantifying the response of a biological system to one or more perturbations based on measured activity data from a subset of entities in the biological system. Systems and methods are described for deriving centrality values based on activity data and a network model of the biological system. The currently available techniques are not based on identifying the underlying mechanisms responsible for the activity of biological entities on a micro-scale, nor do they provide a quantitative assessment of the activation of different biological mechanisms in which these entities play a role, in response to potentially harmful agents and experimental conditions. Accordingly, there is a specific need for improved systems and methods for analyzing system-wide biological data in view of biological mechanisms, and quantifying changes in the biological system as the system responds to an agent or a change in the environment.

In one aspect, the systems and methods described herein are directed to computerized methods and one or more computer processors for quantifying the perturbation of a biological system (for example, in response to a treatment condition such as agent exposure, or in response to multiple treatment conditions). The computerized method may include receiving, at a first processor, a set of treatment data corresponding to a response of a biological system to an agent. The biological system includes a plurality of biological entities, each biological entity interacting with at least one other of the biological entities. The computerized method may also include receiving, at a second processor, a set of control data corresponding to the biological system not exposed to the agent. The computerized method may further include providing, at a third processor, a computational causal network model that represents the biological system. The computational causal network model includes nodes representing the biological entities and edges representing relationships between the biological entities. An edge connects a corresponding first node to a corresponding second node. In some implementations, the edges represent causal activation relationship between nodes.

The computerized method may further include calculating, with a fourth processor, perturbation indices for a subset of the nodes. The perturbation indices are calculated based at least in part on the network model. A perturbation index represents a difference between the treatment data and the control data at a corresponding node and an extent to which activity of the corresponding node is impacted by the perturbation.

The computerized method may further include calculating, with a fifth processor, transition probabilities, for the edges. The transition probabilities for the edges may be calculated based at least in part on the perturbation indices. A transition probability for an edge represents a likelihood of transitioning from the corresponding first node to the corresponding second node. Such transition probabilities may define a Markov chain.

Finally, the computerized method may further include generating, with a sixth processor, centrality values for the nodes. The centrality values for the nodes may be generated based at least in part on the transition probabilities, and a centrality value represents a relative importance of a corresponding node in the network model.

In certain implementations, the perturbation index is a linear combination of activity measures of nodes downstream from the corresponding node. In certain implementations, the transition probability for an edge is based at least in part on the perturbation index of the corresponding second node. In such an implementation, the transition probability for an edge may be a linear function of the perturbation index of the second node.

In certain implementations, the computerized method further includes calculating, with a seventh processor, equilibrium probabilities for the nodes that are representative of the probabilities of a random walk visiting the nodes in the steady state. In such an implementation, the sixth processor may generate the centrality values based at least in part on the equilibrium probabilities.

In certain implementations, the sixth processor generates the centrality value for a corresponding node based at least in part on a number of expected visits of a random walk to the corresponding node between consecutive visits to other nodes. In such an implementation, the centrality value may be a linear combination of the number of expected visits across all nodes in the network.

In certain implementations, the centrality values are normalized by simple centrality values generated based at least in part on simple transition probabilities that are not based on perturbation indices.

In certain implementations, each of the first through sixth processors is included within a single processor or single computing device. In other implementations, one or more of the first through sixth processors are distributed across a plurality of processors or computing devices.

In certain implementations, the computational causal network model includes a set of causal relationships that exist between a node representing a potential cause and nodes representing one or more measured quantities. In such implementations, the activity measures may include a fold-change. The fold-change may be a number describing how much a node measurement changes going from an initial value to a final value between control data and treatment data, or between two sets of data representing different treatment conditions. The fold-change number may represent the logarithm of the fold-change of the activity of the biological entity between the two conditions. The activity measure for each node may include a logarithm of the difference between the treatment data and the control data for the biological entity represented by the respective node. In certain implementations, the computerized method includes generating, with a processor, a confidence interval for each of the generated scores.

In certain implementations, the subset of the biological system includes, but is not limited to, at least one of a cell proliferation mechanism, a cellular stress mechanism, a cell inflammation mechanism, a mechanism of apoptosis, senescence, autophagy, or necroptosis and a DNA repair mechanism. The agent may include, but is not limited to, a heterogeneous substance, including a molecule or an entity that is not present in or derived from the biological system. The agent may also include, but is not limited to, toxins, therapeutic compounds, stimulants, relaxants, natural products, manufactured products, and food substances. The agent may include, but is not limited to, at least one of aerosol generated by heating tobacco, aerosol generated by combusting tobacco, tobacco smoke, and cigarette smoke. The agent may include, but is not limited to, cadmium, mercury, chromium, nicotine, tobacco-specific nitrosamines and their metabolites (4-(methylnitrosamino)-1-(3-pyridyl)-1-butanone (NNK), N′-nitrosonornicotine (NNN), N-nitrosoanatabine (NAT), N-nitrosoanabasine (NAB), and 4-(methylnitrosamino)-1-(3-pyridyl)-1-butanol (NNAL)). In certain implementations, the agent includes a product used for nicotine replacement therapy.

In another aspect, the systems and methods described herein are directed to computerized methods and one or more computer processes for quantifying the perturbation of a biological system. The computerized method may include receiving, at a first processor, a set of first treatment data and receiving, at a second processor, a set of second treatment data. The computerized method may further include providing, at a third processor, a computational causal network model. The network model includes nodes representing biological entities and edges representing relationships between the biological entities. The computerized method may further include calculating, with a fourth processor, perturbation indices for a subset of the nodes. A perturbation index may be calculated based at least in part on the network model and may represent a difference between the first and second treatment data at a corresponding node. The computerized method may further include generating, with a fifth processor, centrality values for corresponding nodes. A centrality value may be generated based at least in part on the perturbation indices and represents a relative importance of the corresponding node in the network model. The computerized method may further include calculating, with a sixth processor, a partial derivative of a centrality value for a first node with respect to the perturbation index for a second node. The partial derivative represents a topological sensitivity measure for the network model. In certain implementations, calculating the partial derivative includes determining an effect of a change in the perturbation index of the second node on a change in the centrality value of the first node.

In another aspect, the systems and methods described herein are directed to computerized methods and one or more computer processes for visualizing perturbation effects on a biological system. The computerized method may include providing, at a first processor, a computational causal network model. The network model includes nodes representing biological entities and edges representing relationships between the biological entities. The computerized method may further include generating, with a second processor, centrality values for corresponding nodes. The centrality values may be generated based at least in part on the network model, and may represent a relative importance of corresponding nodes in the network model. The computerized method may further include calculating, with a third processor, projections of the centrality values onto spectral transform vectors for representing effects of a perturbation on the network model. In certain implementations, calculating projections of the centrality values includes filtering the centrality values. In certain implementations, the computerized method further comprises displaying the network model and displaying one or more components of the projections of the centrality values on the displayed network model. In certain implementations, the edges in the network model are undirected.

In another aspect, the systems and methods described herein are directed to computerized methods and one or more computer processes for quantifying the perturbation of a biological system. The computerized method may include providing, at a first processor, a computational causal network model. The network model includes nodes representing biological entities and edges representing relationships between the biological entities. The computerized method may further include generating, with a second processor, centrality values for corresponding nodes. The centrality values may be generated based at least in part on the network model, and may represent the relative degrees of importance of corresponding nodes in the network model. The computerized method may further include aggegating, with a third processor, the centrality values to generate a score for the network model representing a perturbation of the biological system. In certain implementations, the score is a scalar value. In certain implementations, aggregating the centrality values includes computing a linear combination of the centrality values. In certain implementations, aggregating the centrality values includes computing a linear combination of spectral transforms of the centrality values.

The computerized methods described herein may be implemented in a computerized system having one or more computing devices, each including one or more processors. Generally, the computerized systems described herein may comprise one or more engines, which include a processing device or devices, such as a computer, microprocessor, logic device or other device or processor that is configured with hardware, firmware, and software to carry out one or more of the computerized methods described herein. In certain implementations, the computerized system includes a systems response profile engine, a network modeling engine, and a network scoring engine. The engines may be interconnected from time to time, and further connected from time to time to one or more databases, including a perturbations database, a measurables database, an experimental data database and a literature database. The computerized system described herein may include a distributed computerized system having one or more processors and engines that communicate through a network interface. Such an implementation may be appropriate for distributed computing over multiple communication systems.

### BRIEF DESCRIPTION OF THE DRAWINGS

Further features of the disclosure, its nature and various advantages will be apparent upon consideration of the following detailed description, taken in conjunction with the accompanying drawings, in which like reference characters refer to like parts throughout, and in which:

FIG. 1 is a block diagram of an illustrative computerized system for quantifying the response of a biological network to a perturbation.

FIG. 2 is a flow diagram of an illustrative process for quantifying the response of a biological network to a perturbation by calculating a network perturbation amplitude (NPA) score.

FIG. 3 is a graphical representation of data underlying a systems response profile comprising data for two agents, two parameters, and N biological entities.

FIGS. 4A and 4B are illustrations of computational models of biological networks having several biological entities and their relationships.

FIG. 5 is a flow diagram of an illustrative process for generating centrality values for nodes in a biological network.

FIG. 6 is a more detailed flow diagram of a portion of FIG. 5 showing an illustrative process for generating perturbation indices for a set of nodes.

FIG. 7 is a more detailed flow diagram of a portion of FIG. 5 showing an illustrative process for defining a reinforced random walk on the network.

FIG. 8 is a more detailed flow diagram of a portion of FIG. 5 showing an illustrative process for computing centrality values for a set of nodes.

FIG. 9 is a block diagram of an exemplary distributed computerized system for quantifying the impact of biological perturbations.

FIG. 10 is a block diagram of an exemplary computing device which may be used to implement any of the components in any of the computerized systems described herein.

FIG. 11 is a simplified diagram of a causal network model.

FIG. 12 is a simplified diagram of a causal network.

FIGS. 13 and 14 are simplified diagrams of spectral components of projections of centrality values in a network.

FIG. 15 is a diagram of an example of a lung-focused causal network for cell proliferation.

FIG. 16 is a graph of experimental results for centrality values for node cell proliferation.

### DETAILED DESCRIPTION

The technical terms and expressions used within the scope of this application are generally to be given the meaning commonly applied to them in the pertinent art. The word “comprising” does not exclude other elements or steps, and the indefinite article “a” or “an” does not exclude a plurality. The terms “essentially”, “about”, “approximately” and the like in connection with an attribute or a value particularly also define exactly the attribute or exactly the value, respectively. Described herein are computational systems, computerized methods and products that assess quantitatively the magnitude of changes within a biological system when it is perturbed by an agent. Certain implementations include methods for computing a numerical value that expresses the magnitude of changes within a portion of a biological system. The computation uses as input, a set of data obtained from a set of controlled experiments in which the biological system is perturbed by an agent. The data is then applied to a network model of a feature of the biological system. The network model is used as a substrate for simulation and analysis, and is representative of the biological mechanisms and pathways that enable a feature of interest in the biological system. The feature or some of its mechanisms and pathways may contribute to the pathology of diseases and adverse effects of the biological system. Prior knowledge of the biological system represented in a database is used to construct the network model which is populated by data on the status of numerous biological entities under various conditions including under normal conditions and under perturbation by an agent. The network model used is dynamic in that it represents changes in status of various biological entities in response to a perturbation and can yield quantitative and objective assessments of the impact of an agent on the biological system. Computer systems and products for operating these computational methods are also provided.

The numerical values generated by computerized methods of the disclosure can be used to determine the magnitude of desirable or adverse biological effects caused by one or more of manufactured products (for safety assessment or comparisons), therapeutic compounds including nutrition supplements (for determination of efficacy or health benefits), and environmentally active substances (for prediction of risks of long term exposure and the relationship to adverse effect and onset of disease), among others.

In one aspect, the systems and methods described herein provide a computed numerical value representative of the magnitude of change in a perturbed biological system based on a network model of a perturbed biological mechanism. The numerical value referred to herein as a network perturbation amplitude (NPA) score can be used to summarily represent the status changes of various entities in a defined biological mechanism. The numerical values obtained for different agents or different types of perturbations can be used to compare relatively the impact of the different agents or perturbations on a biological mechanism which enables or manifests itself as a feature of a biological system. Thus, NPA scores may be used to measure the responses of a biological mechanism to different perturbations. The term “score” is used herein generally to refer to a value or set of values which provide a quantitative measure of the magnitude of changes in a biological system. Such a score is computed by using any of various mathematical and computational algorithms known in the art and according to the methods disclosed herein, employing one or more datasets obtained from a sample or a subject.

The NPA scores may assist researchers and clinicians in improving diagnosis, experimental design, therapeutic decision, and risk assessment. For example, the NPA scores may be used to screen a set of candidate biological mechanisms in a toxicology analysis to identify those most likely to be affected by exposure to a potentially harmful agent. By providing a measure of network response to a perturbation, these NPA scores may allow correlation of molecular events (as measured by experimental data) with phenotypes or biological outcomes that occur at the cell, tissue, organ or organism level. A clinician may use NPA values to compare the biological mechanisms affected by an agent to a patient's physiological condition to determine what health risks or benefits the patient is most likely to experience when exposed to the agent (e.g., a patient who is immuno-compromised may be especially vulnerable to agents that cause a strong immuno-suppressive response).

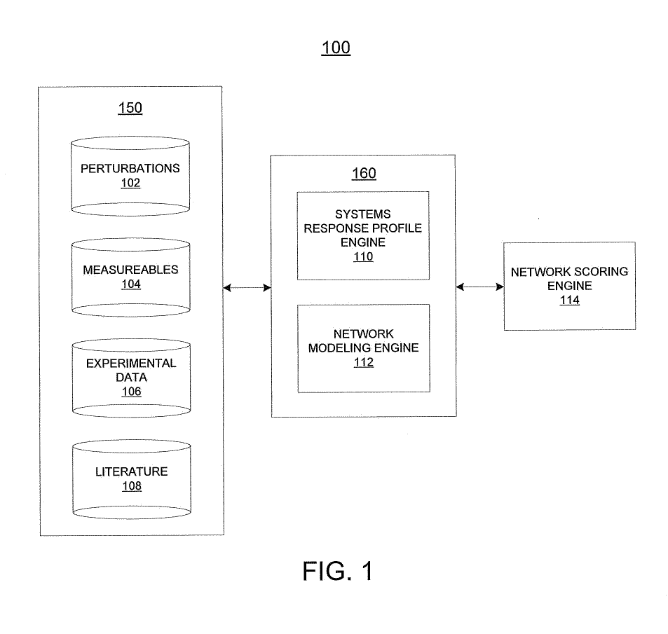

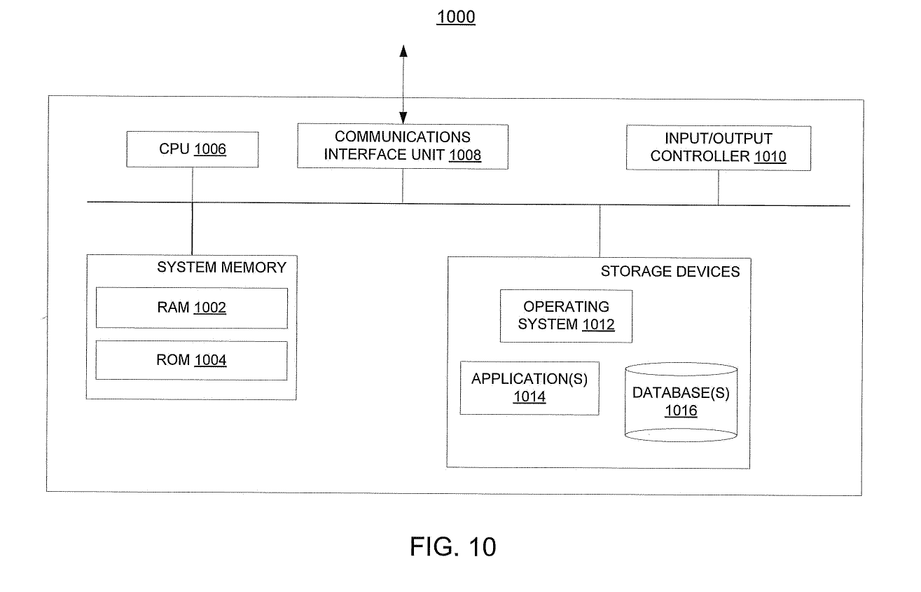

FIG. 1 is a block diagram of a computerized system 100 for quantifying the response of a network model to a perturbation. In particular, system 100 includes a systems response profile engine 110, a network modeling engine 112, and a network scoring engine 114. The engines 110, 112, and 114 are interconnected from time to time, and further connected from time to time to one or more databases, including a perturbations database 102, a measurables database 104, an experimental data database 106 and a literature database 108. As used herein, an engine includes a processing device or devices, such as a computer, microprocessor, logic device or other device or devices as described with reference to FIG. 10, that is configured with hardware, firmware, and software to carry out one or more computational operations.

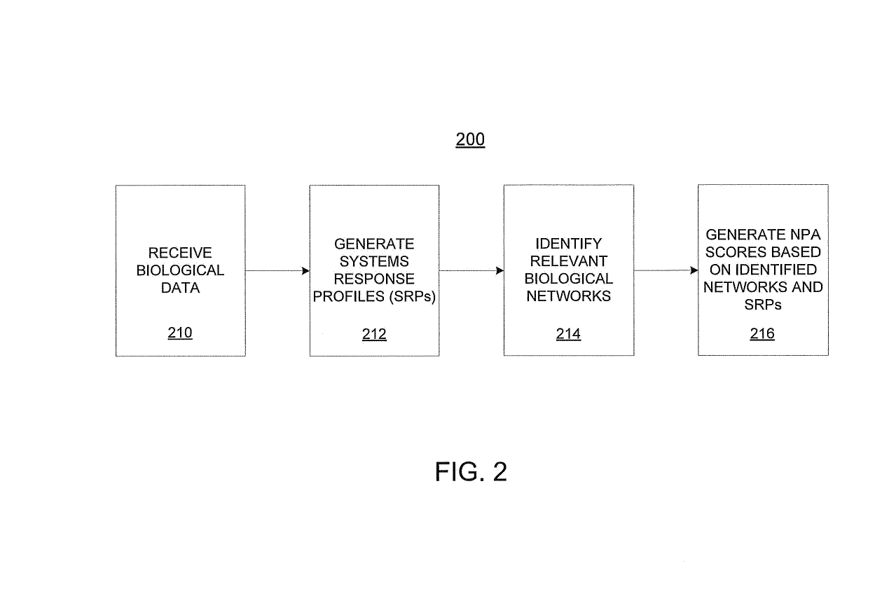

FIG. 2 is a flow diagram of a process 200 for quantifying the response of a biological network to a perturbation by calculating a network perturbation amplitude (NPA) score, according to one implementation. The steps of the process 200 will be described as being carried out by various components of the system 100 of FIG. 1, but any of these steps may be performed by any suitable hardware or software components, local or remote, and may be arranged in any appropriate order or performed in parallel. At step 210, the systems response profile (SRP) engine 110 receives biological data from a variety of different sources, and the data itself may be of a variety of different types. The data includes data from experiments in which a biological system is perturbed, as well as control data. At step 212, the SRP engine 110 generates systems response profiles (SRPs) which are representations of the degree to which one or more entities within a biological system change in response to the presentation of an agent to the biological system. At step 214, the network modeling engine 112 provides one or more databases that contain(s) a plurality of network models, one of which is selected as being relevant to the agent or a feature of interest. The selection can be made on the basis of prior knowledge of the mechanisms underlying the biological functions of the system. In certain implementations, the network modeling engine 112 may extract causal relationships between entities within the system using the systems response profiles, networks in the database, and networks previously described in the literature, thereby generating, refining or extending a network model. At step 216, the network scoring engine 114 generates NPA scores for each perturbation using the network identified at step 214 by the network modeling engine 112 and the SRPs generated at step 212 by the SRP engine 110. An NPA score quantifies a biological response to a perturbation or treatment (represented by the SRPs) in the context of the underlying relationships between the biological entities (represented by the network).

A biological system in the context of the present disclosure includes an organism or a part of an organism, including functional parts, the organism being referred to herein as a subject. The subject is generally a mammal, including a human. The subject can be an individual human being in a human population. The term “mammal” as used herein includes but is not limited to a human, non-human primate, mouse, rat, dog, cat, cow, sheep, horse, and pig. Mammals other than humans can be advantageously used as subjects that can be used to provide a model of a human disease. The non-human subject can be unmodified, or a genetically modified animal (e.g., a transgenic animal, or an animal carrying one or more genetic mutation(s), or silenced gene(s)). The subject can be male or female. Depending on the objective of the operation, a subject can be one that has been exposed to an agent of interest. The subject can be one that has been exposed to an agent over an extended period of time, optionally including time prior to the study. The subject can be one that had been exposed to an agent for a period of time but is no longer in contact with the agent. The subject can be one that has been diagnosed or identified as having a disease. The subject can be one that has already undergone, or is undergoing treatment of a disease or adverse health condition. The subject can also be one that exhibits one or more symptoms or risk factors for a specific health condition or disease. The subject can be one that is predisposed to a disease, and may be either symptomatic or asymptomatic. In certain implementations, the disease or health condition in question is associated with exposure to an agent or use of an agent over an extended period of time. According to some implementations, the system 100 (FIG. 1) contains or generates computerized models of one or more biological systems and mechanisms of its functions (collectively, “biological networks” or “network models”) that are relevant to a type of perturbation or an outcome of interest.

Depending on the context of the operation, the biological system can be defined at different levels as it relates to the function of an individual organism in a population, an organism generally, an organ, a tissue, a cell type, an organelle, a cellular component, or a specific individual's cell(s). Each biological system comprises one or more biological mechanisms or pathways, the operation of which manifest as functional features of the system. Animal systems that reproduce defined features of a human health condition and that are suitable for exposure to an agent of interest are preferred biological systems. Cellular and organotypical systems that reflect the cell types and tissue involved in a disease etiology or pathology are also preferred biological systems. Priority could be given to primary cells or organ cultures that recapitulate as much as possible the human biology in vivo. It is also important to match the human cell culture in vitro with the most equivalent culture derived from the animal models in vivo. This enables creation of a translational continuum from animal model to human biology in vivo using the matched systems in vitro as reference systems. Accordingly, the biological system contemplated for use with the systems and methods described herein can be defined by, without limitation, functional features (for example, biological functions, physiological functions, or cellular functions), organelle, cell type, tissue type, organ, development stage, or a combination of the foregoing. Examples of biological systems include, but are not limited to, the pulmonary, integument, skeletal, muscular, nervous (for example, central and peripheral), endocrine, cardiovascular, immune, circulatory, respiratory, urinary, renal, gastrointestinal, colorectal, hepatic and reproductive systems. Other examples of biological systems include, but are not limited to, the various cellular functions in epithelial cells, nerve cells, blood cells, connective tissue cells, smooth muscle cells, skeletal muscle cells, fat cells, ovum cells, sperm cells, stem cells, lung cells, brain cells, cardiac cells, laryngeal cells, pharyngeal cells, esophageal cells, stomach cells, kidney cells, liver cells, breast cells, prostate cells, pancreatic cells, islet cells, testes cells, bladder cells, cervical cells, uterus cells, colon cells, and rectum cells. Some of the cells may be cells of cell lines, cultured in vitro or maintained in vitro indefinitely under appropriate culture conditions. Examples of cellular functions include, but are not limited to, cell proliferation (e.g., cell division), degeneration, regeneration, senescence, control of cellular activity by the nucleus, cell-to-cell signaling, cell differentiation, cell de-differentiation, secretion, migration, phagocytosis, repair, apoptosis, and developmental programming. Examples of cellular components that can be considered as biological systems include, but are not limited to, the cytoplasm, cytoskeleton, membrane, ribosomes, mitochondria, nucleus, endoplasmic reticulum (ER), Golgi apparatus, lysosomes, DNA, RNA, proteins, peptides, and antibodies.

A perturbation in a biological system can be caused by one or more agents over a period of time through exposure or contact with one or more parts of the biological system. An agent can be a single substance or a mixture or a plurality (for example, one or more) of substances, including a mixture in which not all constituents are identified or characterized. The chemical and physical properties of an agent or its constituents may not be fully characterized. An agent can be defined by its structure, its constituents, or a source that under certain conditions produces the agent. An example of an agent is a heterogeneous substance, that is a molecule or an entity that is not present in or derived from the biological system, and any intermediates or metabolites produced therefrom after contacting the biological system. An agent can be one or more of a carbohydrate, protein, lipid, nucleic acid, alkaloid, vitamin, metal, heavy metal, mineral, oxygen, ion, enzyme, hormone, neurotransmitter, inorganic chemical compound, organic chemical compound, environmental agent, microorganism, particle, environmental condition, environmental force, or physical force. Non-limiting examples of agents include but are not limited to nutrients, metabolic wastes, poisons, narcotics, toxins, therapeutic compounds, stimulants, relaxants, natural products, manufactured products, food substances, pathogens (prion, virus, bacteria, fungi, protozoa), particles or entities whose dimensions are in or below the micrometer range, by-products of the foregoing and mixtures of the foregoing. Non-limiting examples of a physical agent include radiation, electromagnetic waves (including sunlight), increase or decrease in temperature, shear force, fluid pressure, electrical discharge(s) or a sequence thereof, or trauma.

At least some agents or all agents may not perturb a biological system unless it is present at a threshold concentration or it is in contact with the biological system for a period of time, or a combination of both. Exposure or contact of an agent(s) resulting in a perturbation may be quantified in terms of dosage. Thus, a perturbation can result from a long-term exposure to an agent. The period of exposure can be expressed by units of time, by frequency of exposure, or by the percentage of time within the actual or estimated life span of the subject. A perturbation can also be caused by withholding an agent (as described above) from or limiting supply of an agent to one or more parts of the biological system. For example, a perturbation can be caused by a decreased supply of or a lack of one or more nutrients, water, carbohydrates, proteins, lipids, alkaloids, vitamins, minerals, oxygen, ions, an enzyme, a hormone, a neurotransmitter, an antibody, a cytokine, light, or by restricting movement of certain parts of an organism, or by constraining or requiring exercise. Combinations thereof are contemplated.

At least some agents or all agents agent may cause different perturbations depending on which part(s) of the biological system is exposed and the exposure conditions. Non-limiting examples of an agent may include aerosol generated by heating tobacco, aerosol generated by combusting tobacco, tobacco smoke, cigarette smoke, and any of the gaseous constituents or particulate constituents thereof. Further non-limiting examples of an agent include cadmium, mercury, chromium, nicotine, tobacco-specific nitrosamines and their metabolites (4-(methylnitrosamino)-1-(3-pyridyl)-1-butanone (NNK), N′-nitrosonornicotine (NNN), N-nitrosoanatabine (NAT), N-nitrosoanabasine (NAB), 4-(methylnitrosamino)-1-(3-pyridyl)-1-butanol (NNAL)), and any product used for nicotine replacement therapy. An exposure regimen for an agent or complex stimulus should reflect the range and circumstances of exposure in everyday settings. A set of standard exposure regimens can be designed to be applied systematically to equally well-defined experimental systems. Each assay may be designed to collect time and dose-dependent data to capture both early and late events and ensure a representative dose range is covered. However, it will be understood by one of ordinary skill in the art that the systems and methods described herein may be adapted and modified as is appropriate for the application being addressed and that the systems and methods designed herein may be employed in other suitable applications, and that such other additions and modifications will not depart from the scope thereof.

In various implementations, high-throughput system-wide measurements for gene expression, protein expression or turnover, microRNA expression or turnover, post-translational modifications, protein modifications, translocations, antibody production metabolite profiles, or a combination of two or more of the foregoing are generated under various conditions including the respective controls. Functional outcome measurements are desirable in the methods described herein as they can generally serve as anchors for the assessment and represent clear steps in a disease etiology.

A “sample” as used herein refers to any biological sample that is isolated from a subject or an experimental system (e.g., cell, tissue, organ, or whole animal). A sample can include, without limitation, a single cell or multiple cells, cellular fraction, tissue biopsy, resected tissue, tissue extract, tissue, tissue culture extract, tissue culture medium, exhaled gases, whole blood, platelets, serum, plasma, erythrocytes, leucocytes, lymphocytes, neutrophils, macrophages, B cells or a subset thereof, T cells or a subset thereof, a subset of hematopoietic cells, endothelial cells, synovial fluid, lymphatic fluid, ascites fluid, interstitial fluid, bone marrow, cerebrospinal fluid, pleural effusions, tumor infiltrates, saliva, mucous, sputum, semen, sweat, urine, or any other bodily fluids. Samples can be obtained from a subject by means including but not limited to venipuncture, excretion, biopsy, needle aspirate, lavage, scraping, surgical resection, or other means known in the art.

During operation, for a given biological mechanism, an outcome, a perturbation, or a combination of the foregoing, the system 100 can generate a network perturbation amplitude (NPA) value, which is a quantitative measure of changes in the status of biological entities in a network in response to a treatment condition.

The system 100 (FIG. 1) comprises one or more computerized network model(s) that are relevant to the health condition, disease, or biological outcome, of interest. One or more of these network models are based on prior biological knowledge and can be uploaded from an external source and curated within the system 100. The models can also be generated de novo within the system 100 based on measurements. Measurable elements are causally integrated into biological network models through the use of prior knowledge. Described below are the types of data that represent changes in a biological system of interest that can be used to generate or refine a network model, or that represent a response to a perturbation.

Referring to FIG. 2, at step 210, the systems response profile (SRP) engine 110 receives biological data. The SRP engine 110 may receive this data from a variety of different sources, and the data itself may be of a variety of different types. The biological data used by the SRP engine 110 may be drawn from the literature, databases (including data from preclinical, clinical and post-clinical trials of pharmaceutical products or medical devices), genome databases (genomic sequences and expression data, e.g., Gene Expression Omnibus by National Center for Biotechnology Information or ArrayExpress by European Bioinformatics Institute (Parkinson et al. 2010, Nucl. Acids Res., doi: 10.1093/nar/gkq1040. Pubmed ID 21071405)), commercially available databases (e.g., Gene Logic, Gaithersburg, Md., USA) or experimental work. The data may include raw data from one or more different sources, such as in vitro, ex vivo or in vivo experiments using one or more species that are specifically designed for studying the effect of particular treatment conditions or exposure to particular agents. In vitro experimental systems may include tissue cultures or organotypical cultures (three-dimensional cultures) that represent key aspects of human disease. In such implementations, the agent dosage and exposure regimens for these experiments may substantially reflect the range and circumstances of exposures that may be anticipated for humans during normal use or activity conditions, or during special use or activity conditions. Experimental parameters and test conditions may be selected as desired to reflect the nature of the agent and the exposure conditions, molecules and pathways of the biological system in question, cell types and tissues involved, the outcome of interest, and aspects of disease etiology. Particular animal-model-derived molecules, cells or tissues may be matched with particular human molecule, cell or tissue cultures to improve translatability of animal-based findings.

The data received by SRP engine 110 many of which are generated by high-throughput experimental techniques, include but are not limited to that relating to nucleic acid (e.g., absolute or relative quantities of specific DNA or RNA species, changes in DNA sequence, RNA sequence, changes in tertiary structure, or methylation pattern as determined by sequencing, hybridization—particularly to nucleic acids on microarray, quantitative polymerase chain reaction, or other techniques known in the art), protein/peptide (e.g., absolute or relative quantities of protein, specific fragments of a protein, peptides, changes in secondary or tertiary structure, or posttranslational modifications as determined by methods known in the art) and functional activities (e.g., enzymatic activities, proteolytic activities, transcriptional regulatory activities, transport activities, binding affinities to certain binding partners) under certain conditions, among others. Modifications including posttranslational modifications of protein or peptide can include, but are not limited to, methylation, acetylation, farnesylation, biotinylation, stearoylation, formylation, myristoylation, palmitoylation, geranylgeranylation, pegylation, phosphorylation, sulphation, glycosylation, sugar modification, lipidation, lipid modification, ubiquitination, sumolation, disulphide bonding, cysteinylation, oxidation, glutathionylation, carboxylation, glucuronidation, and deamidation. In addition, a protein can be modified posttranslationally by a series of reactions such as Amadori reactions, Schiff base reactions, and Maillard reactions resulting in glycated protein products.

The data may also include measured functional outcomes, such as but not limited to those at a cellular level including cell proliferation, developmental fate, and cell death, at a physiological level, lung capacity, blood pressure, exercise proficiency. The data may also include a measure of disease activity or severity, such as but not limited to tumor metastasis, tumor remission, loss of a function, and life expectancy at a certain stage of disease. Disease activity can be measured by a clinical assessment the result of which is a value, or a set of values that can be obtained from evaluation of a sample (or population of samples) from a subject or subjects under defined conditions. A clinical assessment can also be based on the responses provided by a subject to an interview or a questionnaire.

This data may have been generated expressly for use in determining a systems response profile, or may have been produced in previous experiments or published in the literature. Generally, the data includes information relating to a molecule, biological structure, physiological condition, genetic trait, or phenotype. In some implementations, the data includes a description of the condition, location, amount, activity, or substructure of a molecule, biological structure, physiological condition, genetic trait, or phenotype. As will be described later, in a clinical setting, the data may include raw or processed data obtained from assays performed on samples obtained from human subjects or observations on the human subjects, exposed to an agent.

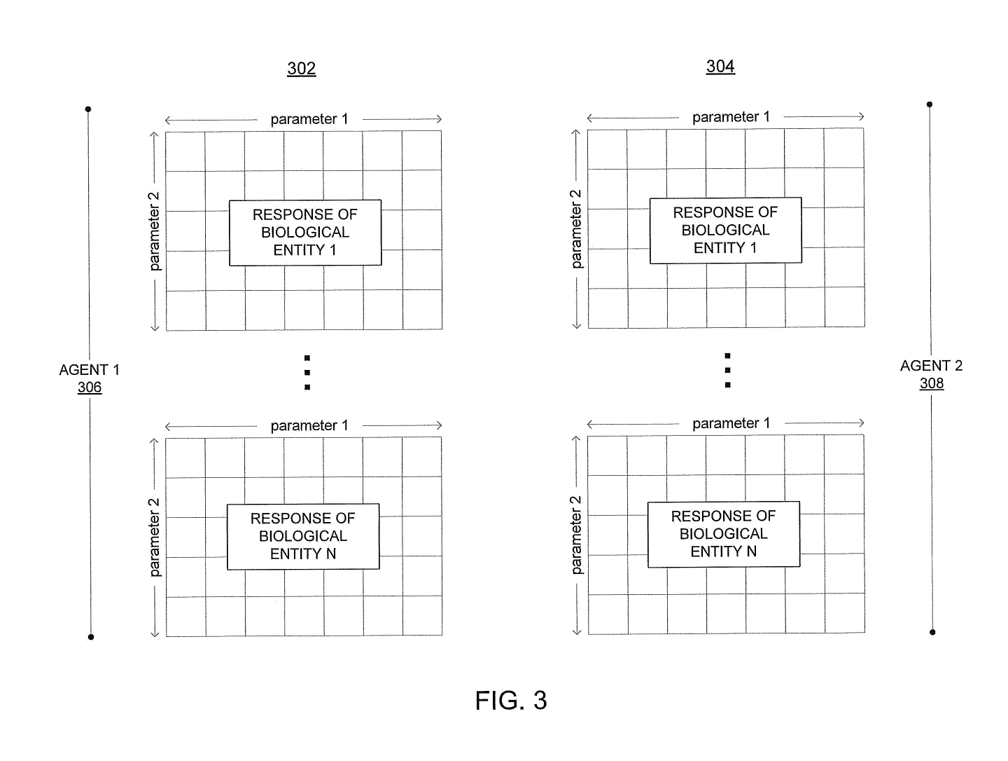

At step 212, the systems response profile (SRP) engine 110 generates systems response profiles (SRPs) based on the biological data received at step 212. This step may include one or more of background correction, normalization, fold-change calculation, significance determination and identification of a differential response (e.g., differentially expressed genes). SRPs are representations that express the degree to which one or more measured entities within a biological system (e.g., a molecule, a nucleic acid, a peptide, a protein, a cell, etc.) are individually changed in response to a perturbation applied to the biological system (e.g., an exposure to an agent). In one example, to generate an SRP, the SRP engine 110 collects a set of measurements for a given set of parameters (e.g., treatment or perturbation conditions) applied to a given experimental system (a “system-treatment” pair). FIG. 3 illustrates two SRPs: SRP 302 that includes biological activity data for N different biological entities undergoing a first treatment 306 with varying parameters (e.g., dose and time of exposure to a first treatment agent), and an analogous SRP 304 that includes biological activity data for the N different biological entities undergoing a second treatment 308. The data included in an SRP may be raw experimental data, processed experimental data (e.g., filtered to remove outliers, marked with confidence estimates, averaged over a number of trials), data generated by a computational biological model, or data taken from the scientific literature. An SRP may represent data in any number of ways, such as an absolute value, an absolute change, a fold-change, a logarithmic change, a function, and a table. The SRP engine 110 passes the SRPs to the network modeling engine 112.

While the SRPs derived in the previous step represent the experimental data from which the magnitude of network perturbation will be determined, it is the biological network models that are the substrate for computation and analysis. This analysis requires development of a detailed network model of the mechanisms and pathways relevant to a feature of the biological system. Such a framework provides a layer of mechanistic understanding beyond examination of gene lists that have been used in more classical gene expression analysis. A network model of a biological system is a mathematical construct that is representative of a dynamic biological system and that is built by assembling quantitative information about various basic properties of the biological system.

Construction of such a network is an iterative process. Delineation of boundaries of the network is guided by literature investigation of mechanisms and pathways relevant to the process of interest (e.g., cell proliferation in the lung). Causal relationships describing these pathways are extracted from prior knowledge to nucleate a network. The literature-based network can be verified using high-throughput data sets that contain the relevant phenotypic endpoints. SRP engine 110 can be used to analyze the data sets, the results of which can be used to confirm, refine, or generate network models.

Returning to FIG. 2, at step 214, the network modeling engine 112 uses the systems response profiles from the SRP engine 110 with a network model based on the mechanism(s) or pathway(s) underlying a feature of a biological system of interest. In certain aspects, the network modeling engine 112 is used to identify networks already generated based on SRPs. The network modeling engine 112 may include components for receiving updates and changes to models. The network modeling engine 112 may also iterate the process of network generation, incorporating new data and generating additional or refined network models. The network modeling engine 112 may also facilitate the merging of one or more datasets or the merging of one or more networks. The set of networks drawn from a database may be manually supplemented by additional nodes, edges, or entirely new networks (e.g., by mining the text of literature for description of additional genes directly regulated by a particular biological entity). These networks contain features that may enable process scoring. Network topology is maintained; networks of causal relationships can be traced from any point in the network to a measurable entity. Further, the models are dynamic and the assumptions used to build them can be modified or restated and enable adaptability to different tissue contexts and species. This allows for iterative testing and improvement as new knowledge becomes available. The network modeling engine 112 may remove nodes or edges that have low confidence or which are the subject of conflicting experimental results in the scientific literature. The network modeling engine 112 may also include additional nodes or edges that may be inferred using supervised or unsupervised learning methods (e.g., metric learning, matrix completion, pattern recognition).

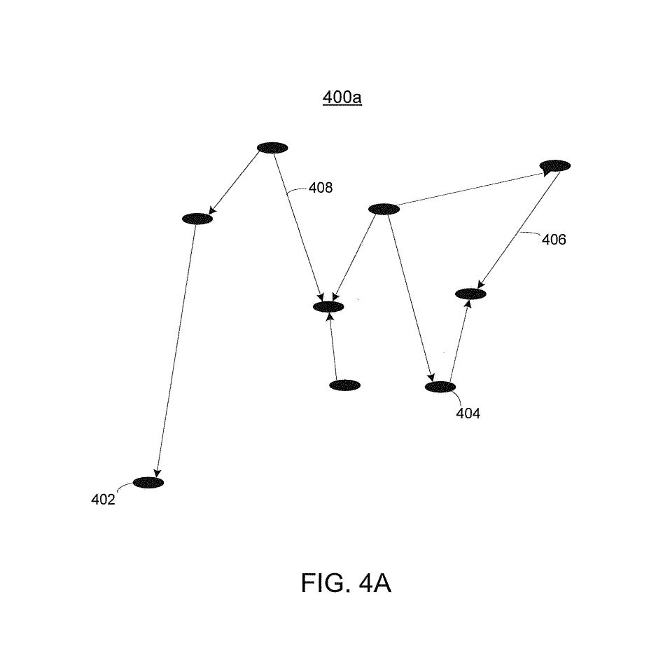

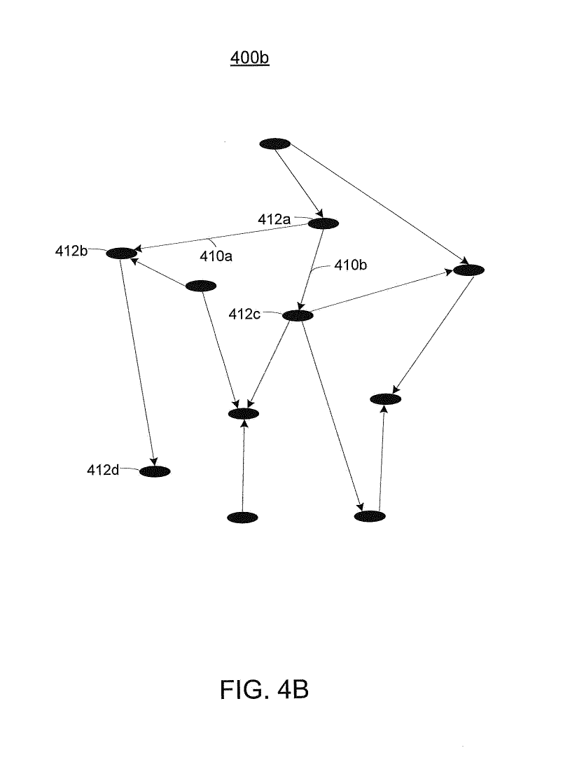

In certain aspects, a biological system is modeled as a mathematical graph consisting of vertices (or nodes) and edges that connect the nodes. For example, FIGS. 4A and 4B illustrate simple networks 400a and 400b respectively. In particular, network 400a includes 9 nodes (including nodes 402 and 404) and edges (406 and 408). The nodes can represent biological entities within a biological system, such as, but not limited to, compounds, DNA, RNA, proteins, peptides, antibodies, cells, tissues, and organs. The edges can represent relationships between the nodes. The edges in the graph can represent various relations between the nodes. For example, edges may represent a “binds to” relation, an “is expressed in” relation, an “are co-regulated based on expression profiling” relation, an “inhibits” relation, a “co-occur in a manuscript” relation, or “share structural element” relation. Generally, these types of relationships describe a relationship between a pair of nodes. The nodes in the graph can also represent relationships between nodes. Thus, it is possible to represent relationships between relationships, or relationships between a relationship and another type of biological entity represented in the graph. For example a relationship between two nodes that represent chemicals may represent a reaction. This reaction may be a node in a relationship between the reaction and a chemical that inhibits the reaction.

The edges of a graph may be directed from one vertex to another. For example, in a biological context, transcriptional regulatory networks and metabolic networks may be modeled as a directed graph. In a graph model of a transcriptional regulatory network, nodes would represent genes with edges denoting the regulatory relationships of gene transcription between them. As another example, protein-protein interaction networks describe direct physical interactions between the proteins in an organism's proteome and there is often no direction associated with the interactions in such networks. Thus, these may be modeled as undirected edges, meaning that there is no distinction between the two vertices associated with an edge. Certain networks may have both directed and undirected edges. The entities and relationships (i.e., the nodes and edges) that make up a graph, may be stored as a web of interrelated nodes in a database in system 100.

The knowledge represented within the database may be of various different types, drawn from various different sources. For example, certain data may represent a genomic database, including information on genes, and relations between them. In such an example, a node may represent an oncogene, while another node connected to the oncogene node may represent a gene that inhibits the oncogene. The data may represent proteins, and relations between them, diseases and their interrelations, and various disease states. There are many different types of data that can be combined in a graphical representation. The computational models may represent a web of relations between nodes representing knowledge in, e.g., a DNA dataset, an RNA dataset, a protein dataset, an antibody dataset, a cell dataset, a tissue dataset, an organ dataset, a medical dataset, an epidemiology dataset, a chemistry dataset, a toxicology dataset, a patient dataset, and a population dataset. As used herein, a dataset is a collection of numerical values resulting from evaluation of a sample (or a group of samples) under defined conditions. Datasets can be obtained, for example, by experimentally measuring quantifiable entities of the sample; or alternatively, or from a service provider such as a laboratory, a clinical research organization, or from a public or proprietary database. Datasets may contain data and biological entities represented by nodes, and the nodes in each of the datasets may be related to other nodes in the same dataset, or in other datasets. Moreover, the network modeling engine 112 may generate computational models that represent genetic information, in, e.g., DNA, RNA, protein or antibody dataset, to medical information, in medical dataset, to information on individual patients in patient dataset, and on entire populations, in epidemiology dataset. In addition to the various datasets described above, there may be many other datasets, or types of biological information that may be included when generating a computation model. For example, a database could further include medical record data, structure/activity relationship data, information on infectious pathology, information on clinical trials, exposure pattern data, data relating to the history of use of a product, and any other type of life science-related information.

The network modeling engine 112 may generate one or more network models representing, for example, the regulatory interaction between genes, interaction between proteins or complex bio-chemical interactions within a cell or tissue. The networks generated by the network modeling engine 112 may include static and dynamic models. The network modeling engine 112 may employ any applicable mathematical schemes to represent the system, such as hyper-graphs and weighted bipartite graphs, in which two types of nodes are used to represent reactions and compounds. The network modeling engine 112 may also use other inference techniques to generate network models, such as an analysis based on over-representation of functionally-related genes within the differentially expressed genes, Bayesian network analysis, a graphical Gaussian model technique or a gene relevance network technique, to identify a relevant biological network based on a set of experimental data (e.g., gene expression, metabolite concentrations, cell response, etc.).

As described above, the network model is based on mechanisms and pathways that underlie the functional features of a biological system. The network modeling engine 112 may generate or contain a model representative of an outcome regarding a feature of the biological system that is relevant to the study of the long-term health risks or health benefits of agents. Accordingly, the network modeling engine 112 may generate or contain a network model for various mechanisms of cellular function, particularly those that relate or contribute to a feature of interest in the biological system, including but not limited to cellular proliferation, cellular stress, cellular regeneration, apoptosis, DNA damage/repair or inflammatory response. In other embodiments, the network modeling engine 112 may contain or generate computational models that are relevant to acute systemic toxicity, carcinogenicity, dermal penetration, cardiovascular disease, pulmonary disease, ecotoxicity, eye irrigation/corrosion, genotoxicity, immunotoxicity, neurotoxicity, pharmacokinetics, drug metabolism, organ toxicity, reproductive and developmental toxicity, skin irritation/corrosion or skin sensitization. Generally, the network modeling engine 112 may contain or generate computational models for status of nucleic acids (DNA, RNA, SNP, siRNA, miRNA, RNAi), proteins, peptides, antibodies, cells, tissues, organs, and any other biological entity, and their respective interactions. In one example, computational network models can be used to represent the status of the immune system and the functioning of various types of white blood cells during an immune response or an inflammatory reaction. In other examples, computational network models could be used to represent the performance of the cardiovascular system and the functioning and metabolism of endothelial cells.

In some implementations of the present disclosure, the network is drawn from a database of causal biological knowledge. This database may be generated by performing experimental studies of different biological mechanisms to extract relationships between mechanisms (e.g., activation or inhibition relationships), some of which may be causal relationships, and may be combined with a commercially-available database such as the Genstruct Technology Platform or the Selventa Knowledgebase, curated by Selventa Inc. of Cambridge, Mass., USA. Using a database of causal biological knowledge, the network modeling engine 112 may identify a network that links the perturbations 102 and the measurables 104. In certain implementations, the network modeling engine 112 extracts causal relationships between biological entities using the systems response profiles from the SRP engine 110 and networks previously generated in the literature. The database may be further processed to remove logical inconsistencies and generate new biological knowledge by applying homologous reasoning between different sets of biological entities, among other processing steps.

In certain implementations, the network model extracted from the database is based on reverse causal reasoning (RCR), an automated reasoning technique that processes networks of causal relationships to formulate mechanism hypotheses, and then evaluates those mechanism hypotheses against datasets of differential measurements. Each mechanism hypothesis links a biological entity to measurable quantities that it can influence. For example, measurable quantities can include an increase or decrease in concentration, number or relative abundance of a biological entity, activation or inhibition of a biological entity, or changes in the structure, function or logical of a biological entity, among others. RCR uses a directed network of experimentally-observed causal interactions between biological entities as a substrate for computation. The directed network may be expressed in Biological Expression Language™ (BEL™), a syntax for recording the inter-relationships between biological entities. The RCR computation specifies certain constraints for network model generation, such as but not limited to path length (the maximum number of edges connecting an upstream node and downstream nodes), and possible causal paths that connect the upstream node to downstream nodes. The output of RCR is a set of mechanism hypotheses that represent upstream controllers of the differences in experimental measurements, ranked by statistics that evaluate relevance and accuracy. Accordingly, in certain implementations, the network model useful in the present disclosure comprises one or more mechanism hypotheses. The mechanism hypotheses output can be assembled into causal chains and larger networks to interpret the dataset at a higher level of interconnected mechanisms and pathways.

One type of mechanism hypothesis comprises a set of causal relationships that exist between a node representing a potential cause (the upstream node or controller) and nodes representing the measured quantities (the downstream nodes). This type of mechanism hypothesis can be used to make predictions, such as if the abundance of an entity represented by an upstream node increases, the downstream nodes linked by causal increase relationships would be inferred to be increase, and the downstream nodes linked by causal decrease relationships would be inferred to decrease.

A mechanism hypothesis represents the relationships between a set of measured data, for example, gene expression data, and a biological entity that is a known controller of those genes. Additionally, these relationships include the sign (positive or negative) of influence between the upstream entity and the differential expression of the downstream entities (for example, downstream genes). The downstream entities of a mechanism hypothesis can be drawn from a database of literature-curated causal biological knowledge. In certain implementations, the causal relationships of a mechanism hypothesis that link the upstream entity to downstream entities, in the form of a computable causal network model, are the substrate for the calculation of network changes by the NPA scoring methods.

In certain embodiments, a complex causal network model of biological entities can be transformed into a single causal network model by collecting the individual mechanism hypothesis representing various features of the biological system in the model and regrouping the connections of all the downstream entities (e.g., downstream genes and their measurable expression levels) to a single upstream entity or process, thereby representing the whole complex causal network model; this in essence is a flattening of the underlying graph structure. Changes in the features and entities of a biological system as represented in a network model can thus be assessed by combining individual mechanism hypotheses.

In certain implementations, the system 100 may contain or generate a computerized model for the mechanism of cell proliferation when the cells have been exposed to cigarette smoke, an aerosol comprising nicotine, an aerosol generated by heating tobacco, or an aerosol generated by combusting tobacco. In such an example, the system 100 may also contain or generate one or more network models representative of the various health conditions relevant to cigarette smoke exposure, including but not limited to cancer, pulmonary diseases and cardiovascular diseases. In certain aspects, these network models are based on at least one of the perturbations applied (e.g., exposure to an agent), the responses under various conditions, the measurable quantities of interest, the outcome being studied (e.g., cell proliferation, cellular stress, inflammation, DNA repair), experimental data, clinical data, epidemiological data, and literature.

As an illustrative example, the network modeling engine 112 may be configured for generating a network model of cellular stress. The network modeling engine 112 may receive networks describing relevant mechanisms involved in the stress response known from literature databases. The network modeling engine 112 may select one or more networks based on the biological mechanisms known to operate in response to stresses in pulmonary and cardiovascular contexts. In certain implementations, the network modeling engine 112 identifies one or more functional units within a biological system and builds a larger network model by combining smaller networks based on their functionality. In particular, for a cellular stress model, the network modeling engine 112 may consider functional units relating to responses to oxidative, genotoxic, hypoxic, osmotic, xenobiotic, and shear stresses. Therefore, the network components for a cellular stress model may include xenobiotic metabolism response, genotoxic stress, endothelial shear stress, hypoxic response, osmotic stress and oxidative stress. The network modeling engine 112 may also receive content from computational analysis of publicly available transcriptomic data from stress relevant experiments performed in a particular group of cells.

When generating a network model of a biological mechanism, the network modeling engine 112 may include one or more rules. Such rules may include rules for selecting network content, types of nodes, and the like. The network modeling engine 112 may select one or more data sets from experimental data database 106, including a combination of in vitro and in vivo experimental results. The network modeling engine 112 may utilize the experimental data to verify nodes and edges identified in the literature. In the example of modeling cellular stress, the network modeling engine 112 may select data sets for experiments based on how well the experiment represented physiologically-relevant stress in non-diseased lung or cardiovascular tissue. The selection of data sets may be based on the availability of phenotypic stress endpoint data, the statistical rigor of the gene expression profiling experiments, and the relevance of the experimental context to normal non-diseased lung or cardiovascular biology, for example.

After identifying a collection of relevant networks, the network modeling engine 112 may further process and refine those networks. For example, in some implementations, multiple biological entities and their connections may be grouped and represented by a new node or nodes (e.g., using clustering or other techniques).

The network modeling engine 112 may further include descriptive information regarding the nodes and edges in the identified networks. As discussed above, a node may be described by its associated biological entity, an indication of whether or not the associated biological entity is a measurable quantity, or any other descriptor of the biological entity, while an edge may be described by the type of relationship it represents (e.g., a causal relationship such as an up-regulation or a down-regulation, a correlation, a conditional dependence or independence), the strength of that relationship, or a statistical confidence in that relationship, for example. In some implementations, for each treatment, each node that represents a measurable entity is associated with an expected direction of activity change (i.e., an increase or decrease) in response to the treatment. For example, when a bronchial epithelial cell is exposed to an agent such as tumor necrosis factor (TNF), the activity of a particular gene may increase. This increase may arise because of a direct regulatory relationship known from the literature (and represented in one of the networks identified by network modeling engine 112) or by tracing a number of regulation relationships (e.g., autocrine signaling) through edges of one or more of the networks identified by network modeling engine 112. In some cases, the network modeling engine 112 may identify an expected direction of change, in response to a particular perturbation, for each of the measurable entities. When different pathways in the network indicate contradictory expected directions of change for a particular entity, the two pathways may be examined in more detail to determine the net direction of change, or measurements of that particular entity may be discarded.

The computational methods and systems provided herein calculate NPA scores based on experimental data and computational network models. The computational network models may be generated by the system 100, imported into the system 100, or identified within the system 100 (e.g., from a database of biological knowledge). Experimental measurements that are identified as downstream effects of a perturbation within a network model are combined in the generation of a network-specific response score. Accordingly, at step 216, the network scoring engine 114 generates NPA scores for each perturbation using the networks identified at step 214 by the network modeling engine 112 and the SRPs generated at step 212 by the SRP engine 110. A NPA score quantifies a biological response to a treatment (represented by the SRPs) in the context of the underlying relationships between the biological entities (represented by the identified networks). The network scoring engine 114 may include hardware and software components for generating NPA scores for each of the networks contained in or identified by the network modeling engine 112.

The network scoring engine 114 may be configured to implement any of a number of scoring techniques, including techniques that generate scalar- or vector-valued scores indicative of the magnitude and topological distribution of the response of the network to the perturbation. In general, perturbation metrics quantify the induced perturbation on a model of a network by a stimulus or an external event. These perturbation metrics may be especially useful in quantifying perturbations induced in biological models by an experimental stimulus, or other networks (such as traffic networks, computer networks, etc.). The perturbation metrics are generated based on two elements. A first element is a computational network model, which may be assembled based on any known data regarding a causal network underlying the system of interest (e.g., a biological network model based on biological mechanisms identified in the scientific literature). A second element is an expression data set describing the behavior of some or all components of the network model when a perturbation is applied to the system of interest. In particular, as used herein, expression nodes typically refer to those nodes in the computational network model for which expression data is available. In some embodiments of perturbation analysis in a biological analysis setting, the network model is constructed from a curated set of biological relationships, and the expression data set is generated by an experiment in which controlled perturbations are applied and monitored. Perturbation analysis methodologies are described herein that identify the most likely perturbed or specific regions of the network, explicitly using the topology of the network.

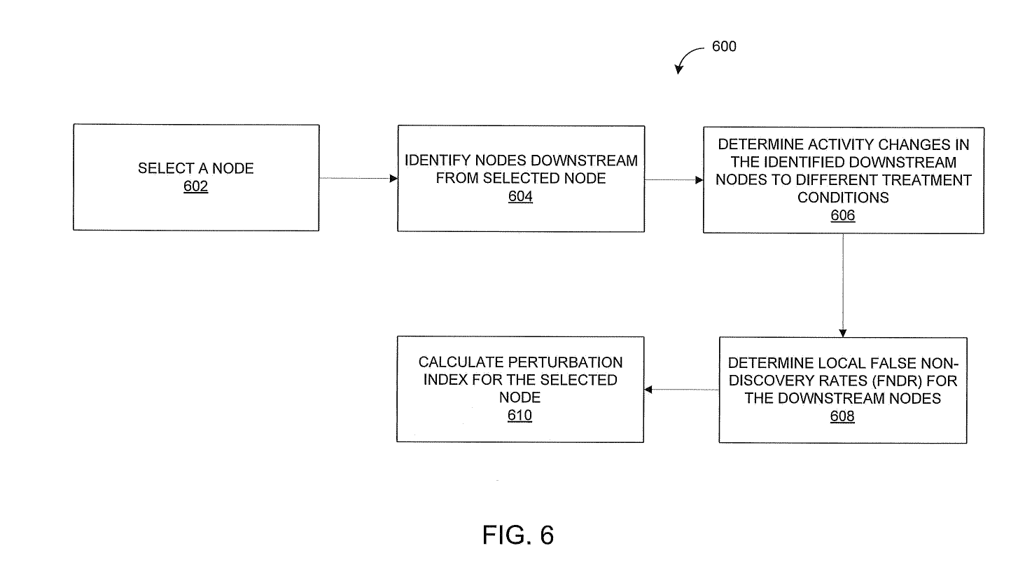

In an example, a perturbation metric is representative of a difference (or a fold-change value) between two data sets (i.e., a treatment data set and a control data set) at a corresponding node. The perturbation metric may be a perturbation index and may represent an extent to which activity of the corresponding node is impacted by a perturbation. In particular, as is described in more detail in relation to FIG. 6, the perturbation index may be computed as a linear combination of measured activities of nodes downstream from the given node.

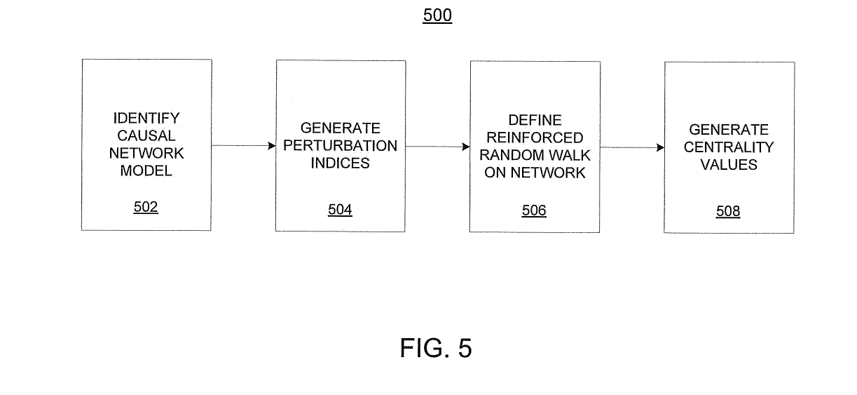

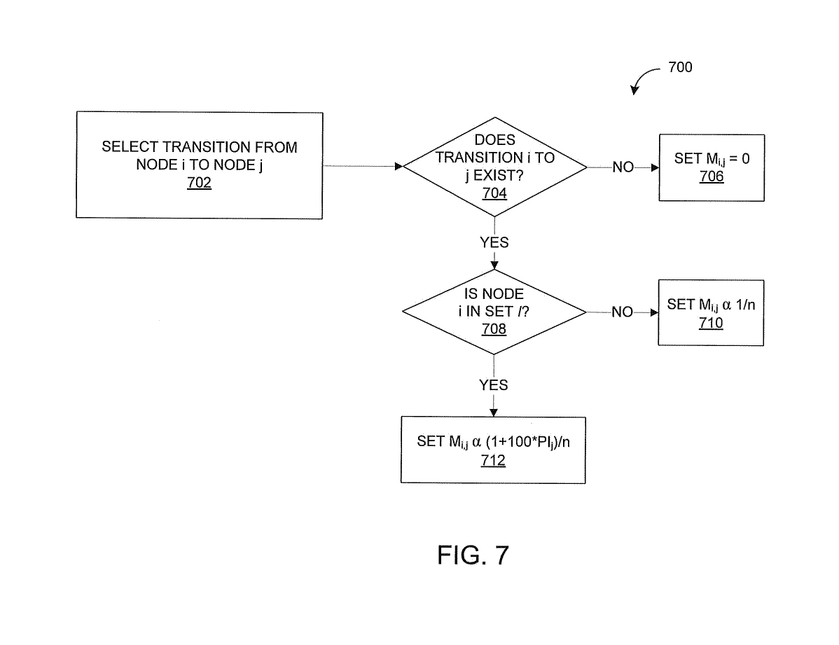

The network model includes nodes that are interconnected over edges, and an edge in the network model may be associated with a transition probability. The transition probability may be indicative of a likelihood of transitioning from one node to another node in the network. As an example, transition probabilities are calculated based at least in part on perturbations metrics representative of a difference between two data sets (i.e., a treatment data set and a control data set) at a corresponding node. As an example, as is described in more detail in relation to FIG. 7, a transition probability may be calculated as a linear function of the perturbation index of a node. Furthermore, the transition probabilities of the edges in the network may be used to determine node metrics. The node metric for a corresponding node may be representative of a relative influence of the node. As is described in more detail in relation to FIG. 5, in addition to calculating transition probabilities for edges in the network, equilibrium probabilities for nodes in the network may also be calculated. An equilibrium probability for a corresponding node is the likelihood in the steady state that the random walk visits the corresponding node.

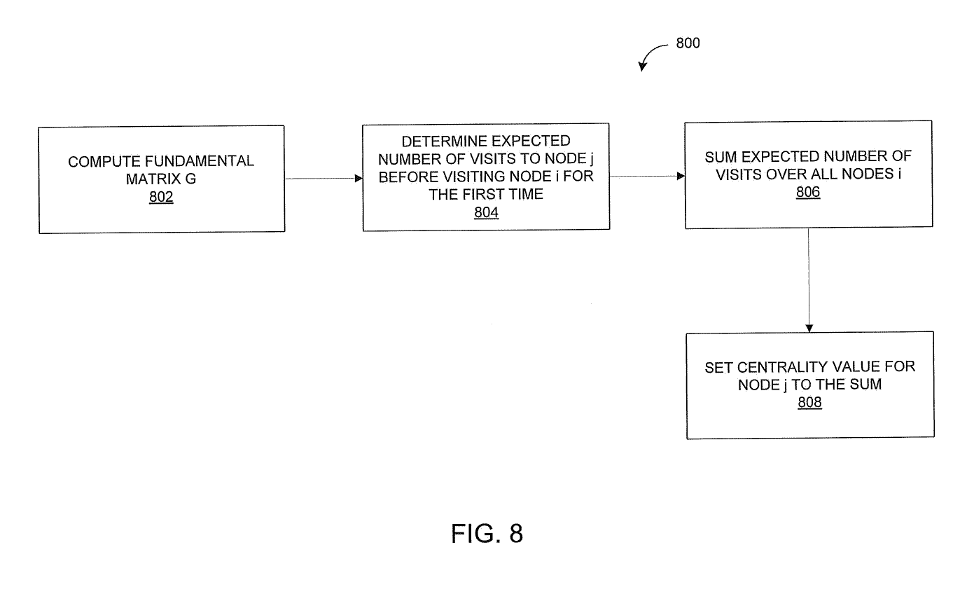

In particular, centrality values for nodes in the network may be computed for representing the relative importance of a node in the network. The relative importance of a node in the network may be representative of relationships between the node and other nodes in the network, and may be dependent on transition probabilities, equilibrium probabilities, or both transition probabilities and equilibrium probabilities in the network. As an example, when the traversals through the network are represented by a random walk model, nodes that are visited more often by the random walk can be relatively more important than other nodes that are less often visited. Thus, nodes that are visited more often have larger centrality values, and calculation of the centrality value for a node may be based on a number of expected visits of a random walk to the corresponding node between consecutive visits to other nodes. In particular, as is described in more detail in relation to FIG. 8, the centrality value may be calculated as a linear combination of the number of expected visits across all nodes in the network. In an example, calculation of a centrality value is based on a “reinforced” random walk model, in which the transition probabilities are based on measured activity levels of downstream nodes.

The centrality values for nodes in a network may be used to study the overall topology of the network. In an example, sensitivity analysis may be performed, in which a perturbation at one node in the network may have an effect on a different node's centrality value. In this manner, the topology of the network is used to understand effects at one location of the network of changes at another location. In another example, the centrality values for nodes in the network may be used to visualize the topology of perturbations across the network. In particular, projecting the centrality values with a spectral transform and displaying a subset of the projections may result in reduced noise so that important pathways in the network may be easily visualized. In another example, the centrality values for nodes in the network may be aggregated to define a scalar value representative of an overall response of the network model to perturbations. In general, centrality values for nodes in a network may be used to study or visualize any topological effect of various perturbations on a network.

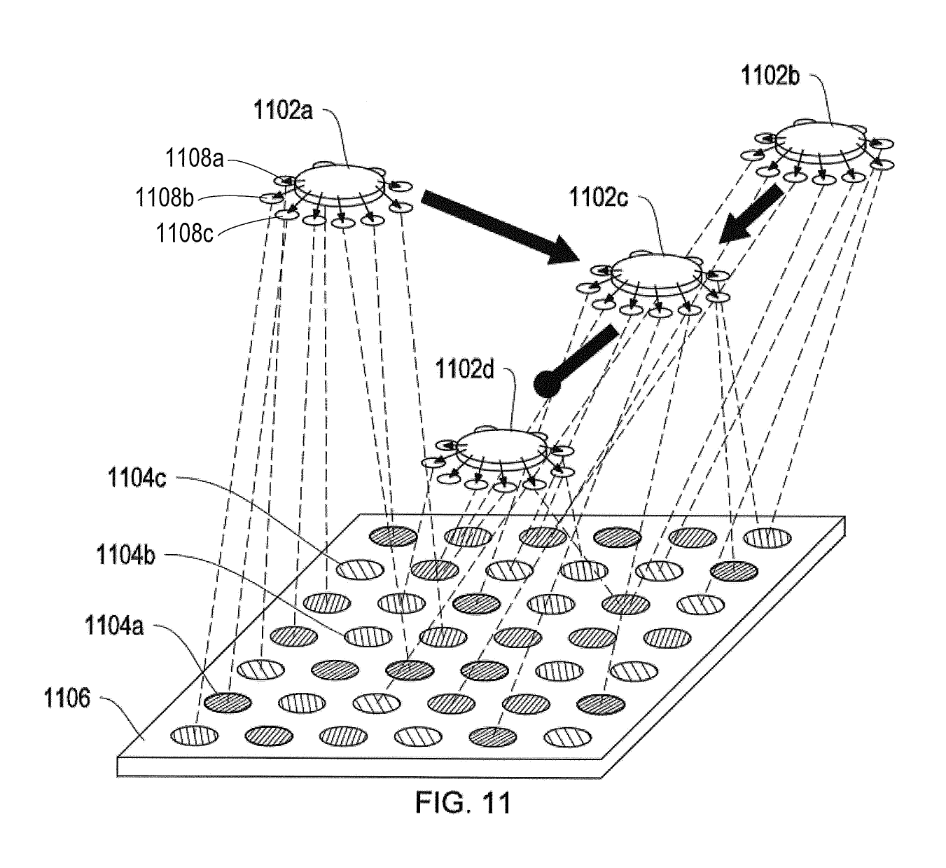

FIGS. 5-8 are flow diagrams of example methods for generating values related to perturbations at nodes in the network, transitions between different nodes in the network, and centrality values for nodes in the network. In addition, FIGS. 4B and 11 are diagrams of example networks including upstream nodes, downstream nodes, and edges, and are described in relation to the flow diagrams in FIGS. 5-8. In particular, the flow diagram in FIG. 5 is an overall method for computing centrality values for nodes, corresponding to a measure of relative importance of a node in a network. The processes shown in FIGS. 6-8 may be used at various steps of the flow diagram in FIG. 5. In particular, the flow diagram in FIG. 6 is one method for calculating a perturbation index of a selected node. The perturbation index is a value associated with activity levels of nodes that are downstream from the selected node. In addition, the perturbation index may be used in the determination of a “reinforced” random walk model, in which the edges connecting different nodes in the network are modified. The reinforced random walk model is described in more detail in relation to FIG. 7. Finally the flow diagram in FIG. 8 is a method for calculating a centrality value based on the reinforced random walk model.

FIG. 5 is a flow diagram of an illustrative process 500 for generating centrality values for nodes in a biological network. As described above, a centrality value represents a relative importance of a node in the network. At step 502, a causal network model for the system of interest is identified. As described above in relation to FIGS. 1 and 2, the network modeling engine 112 may receive and/or generate portions of the model by facilitating the merging of one or more datasets or the merging of one or more networks. A directed network G is the network underlying the causal network model. The n nodes in the network (representing, e.g., biological entities, traffic locations, individuals in social networks) are denoted by (Vᵢ)_{i=1, . . . , m}. The directed network G=(V,E) may be represented by an adjacency matrix A defined in accordance with:

$${A}_{ij} = \{ \begin{matrix}1 & if i -> j \\ 0 & else\end{matrix} \qquad ( 1 )$$

In particular, an element in the adjacency matrix A is 1 if a directed edge exists from a first node i to a second node j. Otherwise, the element in the adjacency matrix A is 0. Let I denote the set of nodes for which there are other nodes (upstream or downstream) to which experimental data can be mapped. The nodes to which experimental data can be mapped may be expression nodes. In particular, the set of nodes I may include any subset of all the m nodes in the network. FIG. 11 illustrates such a scenario, in which four nodes 1102a-1102d (generally, node 1102) in the network are presented. In addition, a gene chip 1106 includes multiple probe sets 1104, in which the shaded pattern and position of each probe set 1104 is representative of an expression level of a certain gene. Each node 1102 has a set of downstream genes 1108a-1108c (generally, downstream gene 1108), and arrows indicate associations between downstream genes 1108 and a subset of the plurality of the probe sets 1104. For clarity, only a subset of the downstream genes 1108 and probe sets 1104 are labeled in FIG. 11. In particular, the scenario illustrated in FIG. 11 is indicative of the link between the causal model and the experimental data.

At step 504, a perturbation index (PI) is generated for each of the nodes in I with at least one downstream measurable node or expression node. In particular, the PI for a node is representative of an amount of downstream activity from the node. In particular, as will be described in more detail below in relation to FIG. 6, downstream nodes may provide supporting evidence for the activity of upstream nodes when a causal relationship exists between the upstream and downstream nodes. In the example network 1100 in FIG. 11, an upstream node 1102 has a causal relationship with downstream nodes 1108. Thus, the PI for the upstream node 1102a is dependent on activity levels at the downstream nodes 1108.

In an example, the PI values represent the extent to which the activity of the node 1102 (e.g., the number of transcriptions in a biological system represented by gene interaction networks or protein-protein interaction networks) is impacted by an applied perturbation at another location in the network 1100. The PIs of the nodes provide information about the evidence that the underlying mechanism has been activated (either inhibited or enhanced). When the perturbation is applied in an experimental setting, the activity of the node may be a relative measurement between the activity of the node in a control condition and the activity of the node in a treatment condition.

FIG. 6 is a flow diagram of an illustrative process 600 for determining a PI for a selected node. The process 600 may be implemented by the network scoring engine 114 or any other suitably configured component of components of the system 100, for example. As depicted in FIG. 6, determining the PI for the selected node includes calculating a linear combination of activity measures of nodes downstream from the selected node. At the step 602, the network scoring engine 114 selects a node i in the set of nodes I. In an example, the network scoring engine 114 selects the node 1102a in the network 1100.

At the step 604, the network scoring engine 114 identifies downstream nodes from the node 1102a selected at the step 602. Downstream nodes may be expression nodes downstream of the selected node i, and may represent gene expression (or measurable nodes 1104, in which the pattern of a measurable node 1104 may correspond to a value of the measured activity level). Downstream nodes may be identified based on the causal network model defined by the adjacency matrix A defined in Eq. 1 above. In particular, the identified downstream nodes may all be separated from the selected node i with a single directed edge (or link), such that the identified downstream nodes are direct neighbors of the selected node 1102a. In addition, the identified downstream nodes may correspond to those direct downstream neighbors of the selected node 1102a which have corresponding measurable nodes 1104.

At the step 606, the network scoring engine 114 determines the activity changes in the identified downstream nodes 1108 (identified at the step 604) to different treatment conditions. In particular, the activity change may be an experimental result of a number describing how much a node measurement changes going from an initial value to a final value between control data and treatment data, or between two sets of data representing different treatment conditions. In particular, for an identified downstream node k, the activity change may be represented by a fold-change βₖ for the node k. In particular, a positive value for βₖ may represent increased activity at the node k as a result of the treatment data, and a negative value for βₖ may represent decreased activity, or vice versa. In some embodiments, the activity change may be the logarithm of the fold-change of the activity of the biological entity between the two conditions. In general, the fold-change βₖ may represent any other indicator (absolute or relative) of the activation of a node k.

At the step 608, the network scoring engine 114 determines the local false non-discovery rates (fndr) for the downstream nodes 1108 identified at the step 604. In particular, the local false non-discovery rate fndr (i.e., the probability that a fold-change value βₖ represents a departure from the underlying null hypothesis of a zero fold-change, in some cases, conditionally on the observed p-value) as described by Strimmer et al. in “A general modular framework for gene set enrichment analysis,” BMC Bioinformatics 10:47, 2009 and by Strimmer in “A unified approach to false discovery rate estimation,” BMC Bioinformatics 9:303, 2008, each of which is incorporated by reference herein in its entirety. In other words, the fndr may be used to represent a probability that the fold-change value βₖ is significantly different from 0, implying that there was a significant difference between two data sets representing different treatment conditions. A high fndr means that the different treatment conditions resulted in significant differences in the data. The local fndr may be based on the false discovery rate fdr (i.e., the probability that a fold-change value βₖ does not represent a departure from the underlying null hypothesis of a zero fold-change). In particular, the local fndr may be defined, for a downstream node k by fndrₖ=1−fdrₖ. In an example, the false discovery rate fdrₖ is dependent at least on an adjusted p-value (i.e., the probability of obtaining a fold-change at least as extreme as the fold-change βₖ that was actually observed, assuming that the null hypothesis of a zero fold-change is true).

At the step 610, the network scoring engine 114 calculates a perturbation index PI for the selected node i (i.e., node 1102a). In particular, PIᵢ may be calculated based on the activity changes and false non-discovery rates of the identified downstream nodes (i.e., nodes 1108). In an example, PIᵢ may be an aggregate measure of the activity changes and false non-discovery rates. As an example, the network scoring engine 114 may calculate PIᵢ as a linear combination of an expression based on the fndr and the absolute values of β of the downstream nodes in accordance with:

$${PI}_{i} = \frac{1}{\vert \{ downstream nodes {V}_{k} \} \vert} {‖ fndr \cdot β ‖}_{{l}^{1} ( \{ downstream nodes {V}_{k} \} )} . \qquad ( 2 )$$

In particular, the downstream nodes 1108 are the children nodes of the selected node 1102a that are of a particular form of expression of a certain gene. These children nodes are those that are directly linked to experimental data. For a downstream node such as nodes 1108, the product between the fndr and the fold-change β represents a scaled version of the difference in data sets resulting from different treatment conditions. In Eq. 2, the network scoring engine 114 calculates the value for PIᵢ as an average of the absolute values of these scaled fold-change values across the downstream nodes of the node i. The scaled fold-change values are representative of activity measures of downstream nodes. In general, PIᵢ may be computed as a linear combination of these scaled fold-change values across the downstream nodes. Thus, for a downstream node with a large and significant fold-change β, the downstream node would give rise to a larger value for the PIᵢ of the upstream node i. Eq. 2 is one method of calculating a PI for a node representative of the extent to which activity of the node is impacted by an applied perturbation. In particular, PI may be a Geometric Perturbation Index (GPI) score dependent on fold-change values as described in Martin et al. BMC systems biology 2012, 6:54 and in pending patent application PCT/EP2012/061035, which are both incorporated herein by reference in its entirety. However, in general, any suitable measure may be used as a PI for a node.

Returning now to FIG. 5, at step 506, the network scoring engine 114 defines a reinforced random walk on the network G. In a reinforced random walk, the transition probability associated with a particular causal relationship depends on the downstream PIs (if y). As an illustrative example, FIG. 4B is a diagram of a network 400b including nodes 412a-412d (generally node 412) and edges 410a-410b (generally edge 410). For clarity, only a subset of the nodes and edges are labeled in network 400b. The edges 410 are directed to indicate that the transition between two nodes connected by an edge occurs in one direction indicated by arrows. As an example, relative to the edge 410a, node 412a may be considered as an upstream node and node 412b may be considered as a downstream node. To reinforce the causal relationship between nodes 412a and 412b, the probability of transitioning from node 412a to node 412b is dependent on the PI value for 412b. In turn, the PI value for node 412b is dependent on the measured activity levels of nodes that are further downstream from node 412b, such as node 412d. The reinforced random walk thus reinforces causal statements based on the PIs of the downstream nodes. Analysis of the reinforced random walk provides information about the importance of each node of the model, since a node that is more likely to be traversed during the random walk will be a node that is central in the network (i.e., the flow of causalities implicate the importance of the node).

Some preliminary notation and explanation are provided below, followed by a description of the reinforced random walk defined at step 506. A random walk on a network G may be represented by a discrete time Markov chain whose state space is V (the node set, or vertex set, of the network) and whose transition probabilities pᵢⱼ are constrained by pᵢⱼ=0 if Aᵢⱼ=0. The transition probabilities pᵢⱼ represent the probability of the random walk moving from node i to node j. The Markov chain may be represented by a transition matrix M (also called the forward propagation operator) defined by Mᵢⱼ=pᵢⱼ. This matrix is stochastic, and together with an initial probability distribution on the vertex set, fully defines a discrete time Markov chain (Xₙ)_{n≧0} on the network. Given the network topology and the causality represented by the edges in the network, the propagation operator M defines a random walk that evolves through the causal relationships between nodes.

When a Markov chain is aperiodic and irreducible, the Markov chain has an equilibrium measure π (i.e., an equilibrium probability) defined in accordance with:

πM=π (3)

In particular, the equilibrium measure π is an m-length vector (where m is the number of nodes in the network). Each element in the equilibrium measure π corresponds to a node in the network and is an overall probability of a random walk visiting the corresponding node in the steady state. After steady state (or equilibrium) has been reached, the probabilities of the random walk visiting any node is fixed in time.

The equilibrium measure π may be computed by an iterative procedure, using the observation that for any measure π, representing an initial distribution, μMⁿ converges to π as n→∞, where n is an integer representative of time. In particular, Mⁿ converges exponentially fast to a rank one matrix M^{∞} that satisfies Mᵢⱼ^{∞}=πⱼ for all nodes i. The ergodic theorem states that if Nₙ⁽ⁱ⁾ represents the number of visits to node i before time n, then

$$\frac{{N}_{n}^{( i )}}{n} \to {π}_{i}$$

with probability 1 as n→∞, for any initial distribution. As will be described in more detail in relation to FIG. 8, the equilibrium measure π may be used to compute a relative importance of a node in the network and thus, the node's centrality value.

The network scoring engine 114 may also define first hitting times, corresponding to a first time at which a node i is visited by a random walk. In particular, the first positive hitting time for node i will be denoted by Tᵢ⁺ and may be calculated in accordance with:

Tᵢ⁺=min{n≧1|Xⁿ=i}, (4)

while the first hitting time for node i will be denoted by T, and may be calculated in accordance with:

Tᵢ=min{n≧0|Xⁿ=i}. (5)

As will be described in more detail in relation to FIG. 8, the first positive hitting time Tᵢ⁺ and the first hitting time Tᵢ may be used to compute centrality values for nodes in a network.

The fundamental matrix or Green's measure of a finite ergodic Markov chain may be defined in accordance with:

G=Σ_{n≧0}(Mⁿ−M^{∞}), (6)

or, equivalently,

Gᵢⱼ=Σ_{n≧0}(pᵢⱼⁿ−πⱼ), (7)

where pᵢⱼⁿ is the probability that the random walk starting at node i is at node j after n steps. In general, the average amount of time spent at node j by the random walk between times 0 and t may be roughly estimated with (t+1)πⱼ, regardless of the starting node i. However, when the starting node i is known, the Green's measure Gᵢⱼ is representative of a correction term to be combined with the rough estimate. In particular, Gᵢⱼ=lim_{t→∞}(Tᵢⱼ(t)−(t+1)πⱼ), where Tᵢⱼ(t) corresponds to an average number of times a random walk starting at node i visits node j between times 0 and t. As will be described in more detail in relation to FIG. 8, the fundamental matrix of the Markov chain may be used to compute centrality values for nodes in a network.

Because Gᵢ=Σ_{n≧0}(δᵢ−π)Mⁿ is a fixed point of the operator μ→μM+(δᵢ−π), this fixed point may be represented as the equilibrium measure of a random walk with a source term δᵢ which continuously provides a source 1 at node i and a uniform sink −π. As a result, the quantity Gᵢ may be represented as a page rank with a source at node i.

The following list enumerates example properties of π and G. These and other properties have been described in further detail by Aldous and Fill in Reversible Markov Chains and Random Walks on Graphs, available at http://www.statberkeley.edu/˜aldous/RWG/book.html and incorporated by reference herein in its entirety. The notation [symbol] _{μ}(•) denotes the expectation for the initial distribution μ. The notation [symbol] ᵢ(•) denotes the expectation for the initial distribution δᵢ.

$$\begin{matrix}{\sum }_{j} {G}_{ij} = 0 for all nodes i and usually G is not self \text{-} adjoint ; & i ) \\ {i}_{} ( {T}_{i}^{+} ) = \frac{1}{{π}_{i}} ; & ii ) \\ {𝔼}_{i} ( number of visits to j before time {T}_{i}^{+} ) = \frac{{π}_{j}}{{π}_{i}} ) ; & iii ) \\ {π}_{i} {𝔼}_{π} ( {T}_{i} ) = {G}_{ii} ; & iv ) \\ {π}_{j} {𝔼}_{π} ( {T}_{j} ) = {G}_{jj} - {G}_{ij} ; & v ) \\ {𝔼}_{π} ( number of visits to j before time {T}_{i} ) = \frac{{π}_{j}}{{π}_{i}} {G}_{ii} - {G}_{ij} . & vi )\end{matrix}$$

The reinforced random walk defined at step 506 is a random walk whose transitions are favored toward the nodes with larger PIs. As an example of a random walk that is not reinforced, all edges in the network may have the same transition probability. However, in a reinforced random walk, the transition preferences may be proportional to the PI or a linear function of the PI. In particular, the transition probability associated with a particular causal relationship (i.e., the edge 410a in the network 400b) depends on the downstream node's PI (i.e., the node 412b). The reinforced random walk thus reinforces causal statements based on the PIs of the downstream nodes. Analysis of the reinforced random walk thus provides information regarding nodes that are more likely to be traversed (i.e., nodes with incoming edges of high probability) during a random walk, and thus important nodes that are central in the network.

In some embodiments, the network scoring engine 114 may use the method 700 in FIG. 7 to calculate the propagation operator Mεl²(V) for the reinforced random walk of step 506. In particular, the propagation operator M is a matrix whose elements correspond to the transition probabilities between nodes. As depicted in FIG. 7, the elements of the matrix M are linear functions of the node PI values. In particular, if d is the number of outgoing edges from a node i (i.e., the outer degree of node i), the propagation operator M may be defined in accordance with:

$${M}_{ij} ∝ \{ \begin{matrix}\frac{1}{d} ( 1 + 10 \cdot {PI}_{j} ) & if i -> j and j ∈ I \\ \frac{1}{d} & if i -> j and j ∉ I \\ 0 & else\end{matrix} \qquad ( 8 )$$

Referring now to FIG. 7, the process 700 may be implemented by the network scoring engine 114 for determining an element Mᵢⱼ of the propagation operator Mm accordance with Eq. 8. At step 702, the network scoring engine 114 selects a transition between two nodes i (i.e., node 412a) and j (i.e., node 412b). In particular, any two nodes in the network may be selected, and a direction may be selected. At decision block 704, the network scoring engine 114 determines whether the directed edge i→j exists (i.e., edge 410a). If the directed edge does not exist, the network scoring engine 114 assigns the element Mᵢⱼ a value of 0 at step 706 because the probability of the transition from node i to node j is 0. If the directed edge does exist, the network scoring engine 114 proceeds to the decision block 708 to determine whether the node i is in the set of nodes I. In an example, the network scoring engine 114 examines the network model to determine at decision block 708 whether the node i is connected (i.e., upstream or downstream) to any expression nodes or any other nodes to which experimental data can be mapped. In particular, the set of nodes I is the set of nodes 1102 which have direct links to experimental data. In particular, if the node i is not in the set of nodes I, the network scoring engine 114 assigns the element Mᵢⱼ a value proportional to 1/n at step 710 (i.e., Mᵢⱼ α 1/n). Otherwise, the network scoring engine 114 assigns the element Mᵢⱼ to a value proportional to 1/n(1+100·PIⱼ) at step 712 (i.e., Mᵢⱼ α (1+100·PIⱼ)/n). In particular, the values of the elements Mᵢⱼ may be normalized such that the sum of the elements Mᵢⱼ across j is equal to one.

The process 700 shown in FIG. 7 is one example of an implementation of modification of the probabilities of transition between different nodes in the network by preferentially weighting transitions based on PI values. However, in general, any suitable method may be used for modifying the transition probabilities.

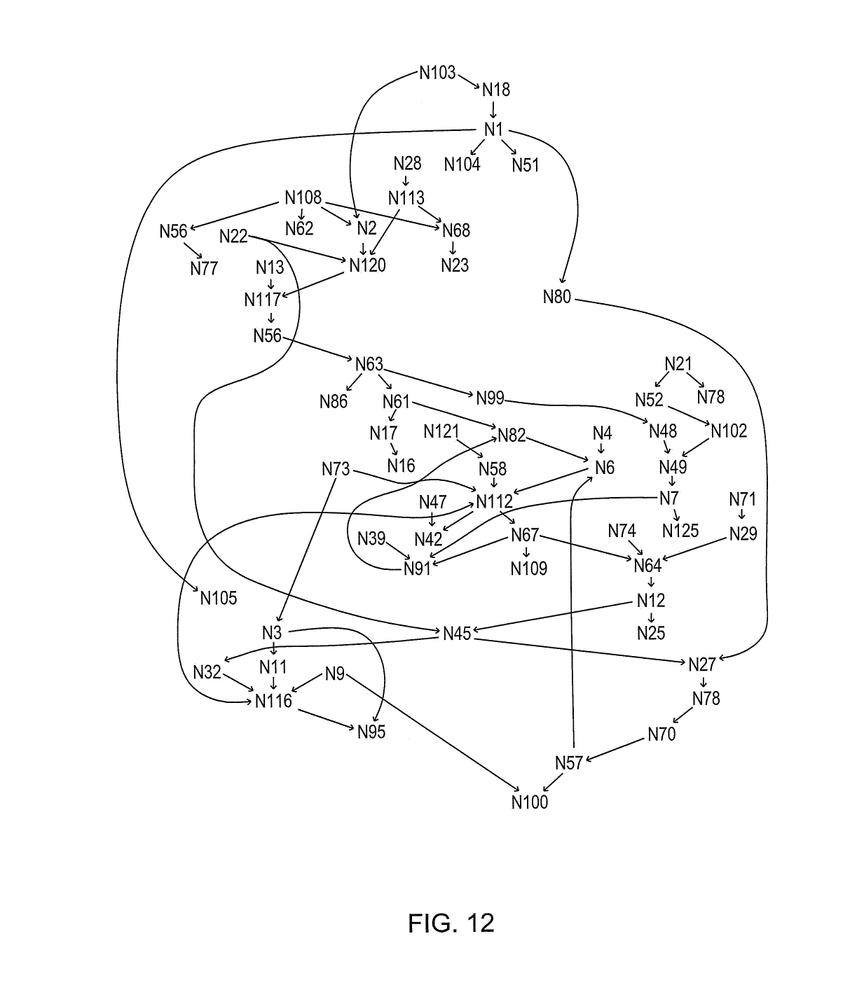

In addition, the Markov chain defined by the transition probabilities of Eq. 8 is not necessarily irreducible. For example, an absorbing node may exist (such as apoptosis in a biological network representing cell activity). As an example, the nodes N23, N51, N77, N95, N100, and N104 in the network of FIG. 12 are examples of absorbing nodes that have only incoming edges and no outgoing edges. In some embodiments, this issue is addressed by including additional transition probabilities to allow the random walk to escape to one or more designated nodes (for example, a node with no upstream nodes). In some embodiments, this issue is addressed by including additional transition probabilities to allow the random walk to make a random jump at some or all nodes.

Referring now to FIG. 5, at step 508, centrality values are generated for individual nodes in the network. In general, a centrality value for anode quantifies the relative importance of the node in the network. For example, the centrality value for a node may be defined with respect to other nodes in the network. In particular, the centrality value for a selected node may be calculated based on an expected number of visits to the selected node before the reinforced random walk visits another node for the first time. One example of a centrality value is described by White and Smyth in Algorithms for estimating relative importance in networks, International Conference on Knowledge Discovery and Data Mining, Proceedings of the Ninth ACM SIGKDD International Conference on Knowledge Discovery and Data Mining 2003, pp. 266-275, incorporated by reference in its entirety herein.

Referring now to FIG. 8, the process 800 may be implemented by the network scoring engine 114 for generating a centrality value for a node in the network. As described above, a centrality value for a node represents a relative importance of a node in the network, and may be representative of relationships between the node and other nodes in the network. In addition, a centrality value may be dependent on a reinforced random walk model (as defined for the propagation operator M in relation to FIG. 7). In an example, the centrality value for a corresponding node is calculated based on a number of expected visits of a random walk to the corresponding node between consecutive visits to other nodes. In this way, the centrality value is representative of an expected number of times a random walk visits the node and is therefore indicative of a relative importance of the node in the network.

In particular, at the step 802, the network scoring engine 114 computes the fundamental matrix G in accordance with Eqs. 6 and 7. At the step 804, the network scoring engine 114 determines an expected number of visits to anode j before a first visit to anode i. In some embodiments, the property (vi) from the above list of properties is applied at the step 804. At the step 806, the network scoring engine 114 sums the expected number of visits over all nodes i, and at the step 808, the centrality value for node j is set to the sum computed at step 806. In particular, the Markov centrality for a node j is calculated in accordance with:

C(j)=Σ_{i=1, . . . , m}(πⱼ/πᵢGᵢᵢ−Gᵢⱼ) (9)

=Σ_{i=1, . . . , m} [symbol] _{π}(number of visits to j before time Tᵢ) (10)

Therefore, the centrality value for a node j is based on a number of times it is expected for a random walk to visit the node j before visiting another node. In an extreme case, if one node j1 is visited many times before the random walk visits other nodes for the first time, then the node j1 is relatively important, resulting in a large centrality value C(j1). On the other hand, if a node j2 is not visited before the random walk visits other nodes for the first time then the node j2 is relatively unimportant, resulting in a smaller centrality value C(j2).

In some embodiments, to compute a centrality value for an individual node j, the Markov centralities of the reinforced random walk (defined at step 506) may be combined with centralities computed for a random walk that is not reinforced by any data (i.e., with PIᵢ=0 for all nodes i). A random walk that is not reinforced may be referred to as a simple random walk (SRW), and a comparison between the reinforced random walk and a SRW may distinguish the impact of including the PIs in the reinforced random walk. Denote the Markov centralities of the SRW by C^{SRW}(j). In some embodiments, the centrality values are generated in accordance with:

$$R ( j ) = {log}_{10} ( \frac{C ( j )}{{C}^{SRW} ( j )} ) \qquad ( 11 )$$

By using a centrality value that includes the reinforced Markov chain centralities and the centralities of the SRW, the observed behavior of the system of interest is able to reinforce the pathways within the network model. If all of the PI values in the reinforced random walk are zero, then R(j) is zero for all j.

Eqs. 9-11 are illustrative examples of various techniques for calculating a centrality value for a node, and the different techniques may offer different advantages. For example, Eq. 11 represents the centrality values of the reinforced random walk as normalized values with respect to a SRW and is an invariant measure in this manner. The expected number of visits approach described in Eq. 10 may be more sensitive to reinforcement by the PIs than the invariant approach. Finally, the Green measure described in Eq. 9 may also be used to provide centrality values, but does not provide the ready probabilistic interpretation as the expected number of visits approach.

In general, the techniques described herein may be applied to any setting in which a network model is used to represent a system for which experimental or observed data is available. For example, a traffic network may be represented by a network whose edges are weighted by road capacity, each node is a road crossing, and expression nodes may be road crossings for which accident or traffic jam data is available. The accident or traffic jam data may be used to bias the random walk model and predict the behavior at road crossings in response to changes in traffic. In another example, a web network may be represented by a network whose edges are links between web pages, each node is web page, and expression nodes may be pages for which visitor data is available. The visitor data may be used to bias the random walk model and predict the visits to web pages in response to changes in web surfing habits.

The centrality values for nodes in a network computed in FIGS. 5 and 8 may be used to study the overall topology of the network. At least three examples methods for using the centrality values in a network to study the network's topology are described herein. In one example, the network scoring engine 114 may perform sensitivity analysis, which studies the effect of a perturbation at one node in the network on a different node's centrality value. In this manner, the topology of the network is used to understand effects at one location of the network of changes at another location. In a second example, the centrality values for nodes in the network may be used to visualize the topology of perturbations across the network. In particular, these visualization methods may result in reduced noise so that important pathways in the network may be easily visualized. In a third example, the centrality values for nodes in the network may be aggregated to define a scalar value representative of an overall response of the network model to perturbations. These three examples are described in more detail below. However, in general, centrality values for nodes in a network may be used to study or visualize any topological effect of various perturbations on a network.

In some implementations, it is desirable for the network scoring engine 114 to perform a sensitivity analysis to understand the relationship between a change in a perturbation index for a node and a centrality value for another (or the same) node. A deeper analysis of the network can be performed by understanding the impact of the experimental evidence (e.g., via a PI value) on the centrality values of the network nodes. In some embodiments, the sensitivity analysis includes determining a value of or an approximation to the following expression:

$$\frac{\partial R ( j )}{\partial {PI}_{k}} . \qquad ( 12 )$$

The expression of Eq. 12 may be written as:

$$\frac{\partial C ( j ) / \partial {PI}_{k}}{C ( j )} - \frac{\partial {C}^{SRW} ( j ) / \partial {PI}_{k}}{{C}^{SRW} ( j )} . \qquad ( 13 )$$

The fundamental matrix G may be represented as:

G=(I−(M−M^{∞}))⁻¹−M^{∞}. (14)

Additionally, [symbol] _{π}(number of visits to j before time Tᵢ) can be expressed as

$$diag ( G ) ( \frac{1}{π} ) {π}^{T} - G . \qquad ( 15 )$$

### Thus,

$$\begin{matrix}\frac{\partial G}{\partial {PI}_{k}} = - ( G + {M}^{∞} ) ( \frac{\partial ( I - M )}{\partial {PI}_{k}} + 1 \cdot \frac{\partial {π}^{T}}{\partial {PI}_{k}} ) ( G + {M}^{∞} ) - \frac{\partial {M}^{∞}}{\partial {PI}_{k}} ( 16 ) \\ = ( G + {M}^{∞} ) ( \frac{\partial ( M - I - 1 {π}^{T} )}{\partial {PI}_{k}} ) ( G + {M}^{∞} ) - \frac{\partial 1 {π}^{T}}{\partial {PI}_{k}} ( 17 ) \\ = ( G + {M}^{∞} ) ( \frac{\partial M}{\partial {PI}_{k}} - 1 \cdot \frac{\partial {π}^{T}}{\partial {PI}_{k}} ) ( G + {M}^{∞} ) - 1 \cdot \frac{\partial {π}^{T}}{\partial {PI}_{k}} ( 18 )\end{matrix}$$

Using the result of Eq. 18 with the expression of Eq. 10 yields:

$$\begin{matrix}\frac{\partial C ( j )}{\partial {PI}_{k}} = \frac{\partial }{\partial {PI}_{k}} ( diag ( G ) ( \frac{1}{π} ) {π}^{T} - G ) & ( 19 ) \\ = \frac{\partial diag ( G )}{\partial {PI}_{k}} ( \frac{1}{π} ) {π}^{T} + diag ( G ) \frac{\partial ( \frac{1}{π} )}{\partial {PI}_{k}} {π}^{T} + \\ = diag ( G ) ( \frac{1}{π} ) \frac{\partial {π}^{T}}{\partial {PI}_{k}} - \frac{\partial G}{\partial {PI}_{k}} \\ where & ( 20 ) \\ \frac{\partial ( \frac{1}{π} )}{\partial {PI}_{k}} = - ( \frac{1}{{π}^{2}} ) \cdot \frac{\partial π}{\partial {PI}_{k}} \\ and & ( 21 ) \\ \frac{\partial diag ( G )}{\partial {PI}_{k}} = diag ( \frac{\partial G}{\partial {PI}_{k}} ) . & ( 22 )\end{matrix}$$

Additionally, since M^{T}π^{T}=π^{T},

$$0 = \frac{\partial ( {M}^{T} - I ) {π}^{T}}{\partial {PI}_{k}} \qquad ( 23 )$$

and thus

$$\begin{matrix}\frac{\partial {π}^{T}}{\partial {PI}_{k}} = - ( {M}^{T} - I ) + \frac{\partial ( {M}^{T} - I )}{\partial {PI}_{k}} {π}^{T} & ( 24 ) \\ \frac{\partial π}{\partial {PI}_{k}} = - π \frac{\partial ( M - I )}{\partial {PI}_{k}} {( M - I )}^{+} . & ( 25 )\end{matrix}$$

Finally, using the definition of the reinforced Markov chain given in Eq. 8,

$$\begin{matrix}\frac{\partial {M}_{ik}}{\partial {PI}_{k}} = \frac{{M}_{ij}}{degout ( i ) \cdot {Σ}_{j} {M}_{ij}^{2}} & ( 26 ) \\ \frac{\partial {M}_{ik}}{\partial {PI}_{k}} = \frac{- {M}_{ij}}{degout ( i ) \cdot {Σ}_{j} {M}_{ij}^{2}} for ( j \neq k , i \to j ) & ( 27 ) \\ \frac{\partial {M}_{ik}}{\partial {PI}_{k}} = 0 for not ( i \to j ) & ( 28 )\end{matrix}$$

The relationships of Eqs. 14-28 may be used with the expression of Eq. to determine a measure of the sensitivity of the centrality values on the perturbation indices.

In some implementations, it is desirable to filter, modify or both filter and modify the centrality values to improve presentation and interpretation of the results. In particular, the centrality values (generated according to the process of flow diagram 500 of FIG. 5) may be projected using spectral transform vectors for visually representing effects of a perturbation on the network. One tool from graph theory that is useful in this context is the graph combinatorial Laplacian. The combinatorial Laplacian is independent of the direction of a directed network, and thus is not readily modified to incorporate causal relationships as described above with reference to the reinforced random walk. Therefore, the causality of the network is removed. In particular, let G⁰ denote the undirected network defined by removing the directionality of G (i.e., by making all edges bi-directional) and let L_{G}_{⁰} be the graph combinatorial Laplacian defined according to:

$${L}_{{G}^{0}} ( i , j ) = \{ \begin{matrix}deg ( i ) & if i = j \\ - 1 & if i \sim j \\ 0 & else\end{matrix} \qquad ( 29 )$$

In particular, the expression i˜j is satisfied when an edge between nodes i and j exists, such that the rows of the Laplacian L_{G}_{⁰} sum to zero. The Laplacian L_{G}_{⁰} is symmetric positive and hence its spectrum is real positive. The heat kernel of the network is the fundamental solution of

$$\frac{δ}{δ t} f = - {L}_{{G}^{0}} f ,$$

∀fεl²(V⁰). The i-th row of the solution, which may be represented as

$${e}^{- t \cdot {L}_{{G}^{0}}} ,$$

provides the solution of the diffusion equation for a Dirac heat source at i, δᵢ. Additionally, the spectral transform of gεl²(V⁰), in which g is a vector with m entries and may be calculated in accordance with:

F(g)=Σ_{iεV}_{⁰}e^{-λ}^{_{i<g|φ}}ᵢ>φᵢ (30)

where φᵢ are the eigenvectors of L_{G}_{⁰} and λᵢ the corresponding eigenvalues. In particular, <g|φᵢ> is the l² scalar product of g and φᵢ. In an example, g may be normalized to unit magnitude such that

$$\frac{< g \vert {φ}_{i} {>}^{2}}{{‖ g ‖}_{2}^{2}}$$

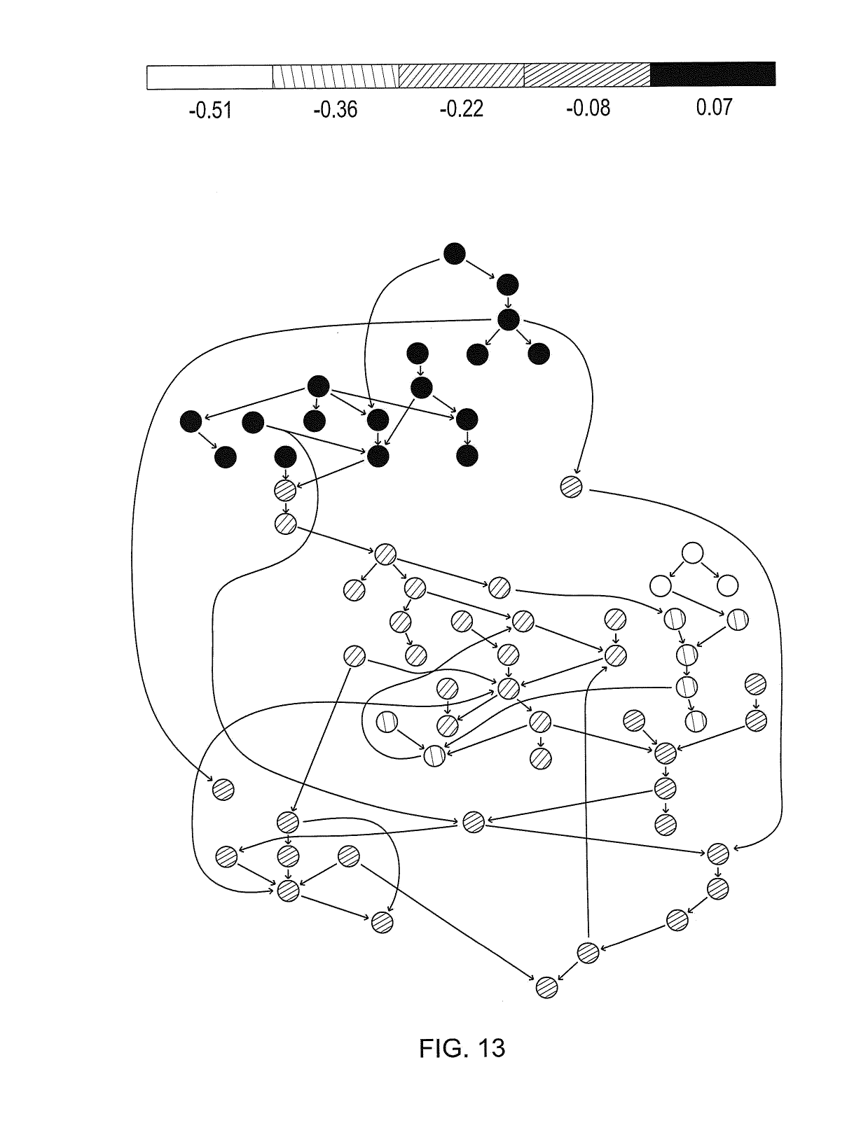

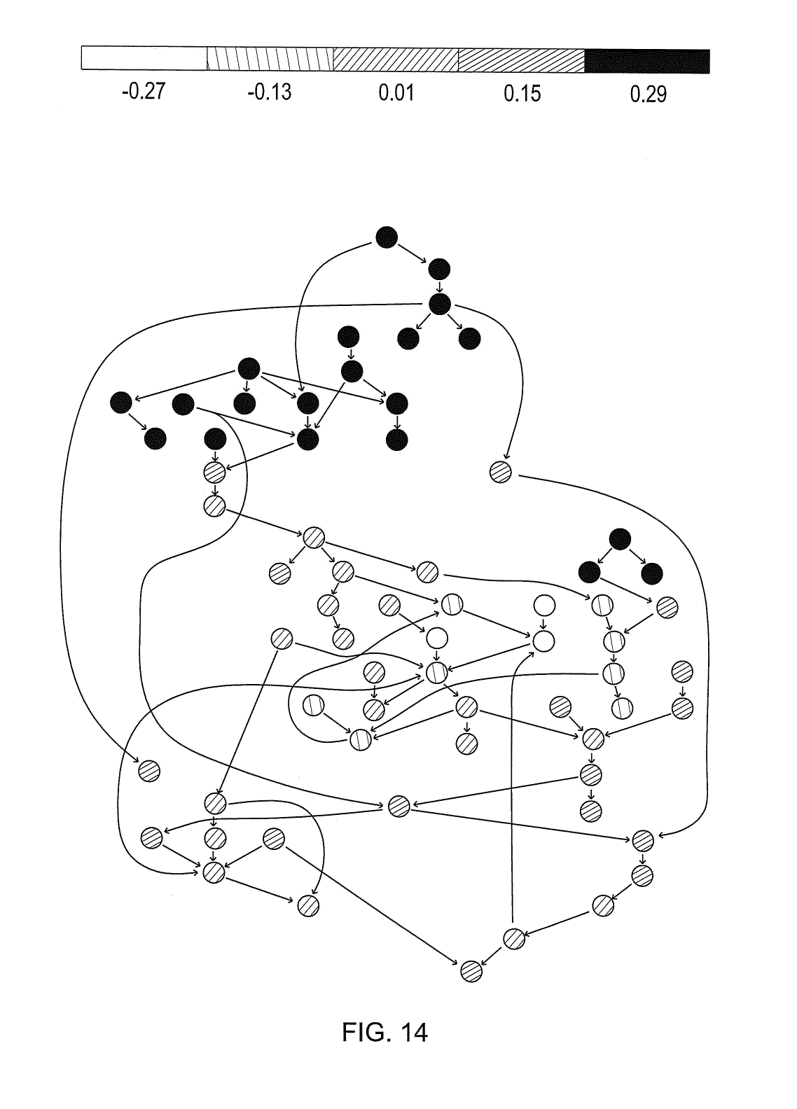

is used in Eq. 30. The usual convention is to sort the eigenvalues as 0≦λ₁≦λ₂≦ . . . ≦λₘ. In some embodiments, the centrality values calculated according to flow diagram 500 of FIG. 5 may be projected onto the spectral transform vectors of Eq. 30. Projecting the centrality values, and only displaying the projections for a limited number of the spectral transform vectors, may reduce noise and clarify the dominant pathways in the network. Such a projection may be used as a multivariate network perturbation amplitude (NPA) metric, representing the response of the network model to the experimental perturbations. Examples of such projections are provided in FIGS. 13 and 14, which use different patterns for different nodes to indicate the projection values for the spectral transform vectors associated with the two smallest non-zero eigenvalues.

In some implementations, it is desirable to aggregate across the centrality values for multiple nodes in the network model to define a scalar value representative of the response of the network model to perturbations. Instead of or in addition to a multivariate network perturbation amplitude (NPA) metric as described above, a scalar-valued network perturbation amplitude (NPA) metric may be used to represent the response of the network model to the experimental perturbations. The centrality values described above may be combined in any number of ways, and with any number of additional sources of information, to generate a scalar-valued NPA metric. For example, any one or more of the following approaches may be used.

1. The l²-norm of log₁₀(Cⱼ):

$${Σ}_{j} \vert {log}_{10} ( \frac{C ( i )}{{C}^{SRW} ( i )} ) \vert$$

2. The norm of the spectral transform of the log₁₀ of the centrality values (i.e., the linear combination of the projections of the centrality ratios onto the spectral transform vectors Nⱼ weighted by exp−λⱼ. By using the topology to generate the centrality values, and also using the topology to generate the spectral transform vectors, this approach provides another level of granularity to distinguish two perturbations that may have very similar global (scalar-valued) scores, but not the same topological profiles.

3. The cover time of the reinforced random walk, defined as the random variable C=maxⱼTⱼ. The exact computation of maxᵥ [symbol] ᵥ(C) may be computationally difficult, but an upper bound is given by Matthew's theorem according to

$${\sum }_{k}^{n - 1} \frac{1}{k}$$

. This upper bound can be used to build a NPA metric, as it represents the time for a perturbation to propagate asymptotically to the whole network.

The description of cellular processes and the quantitative analysis of their perturbations aids in understanding disease. A network model that describes non-kinetic causal relationships between biological processes has been studied. In this network model, some nodes are associated with a set of genes which correspond to the downstream targets of the process described by the node. The agreement between the behavior contained in the model and the behavior observed at the gene expression level in a particular experiment allows us to quantify the activity of the corresponding node. Thus network models help link short term molecular biological observations to disease related phenotypic endpoints.

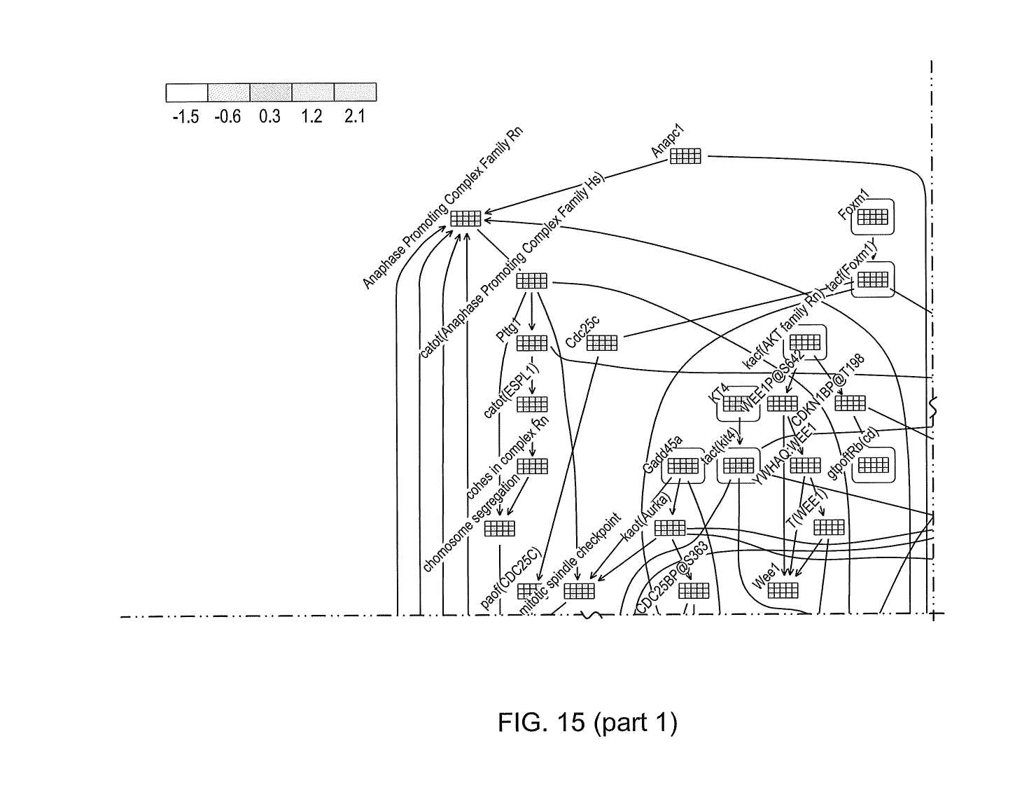

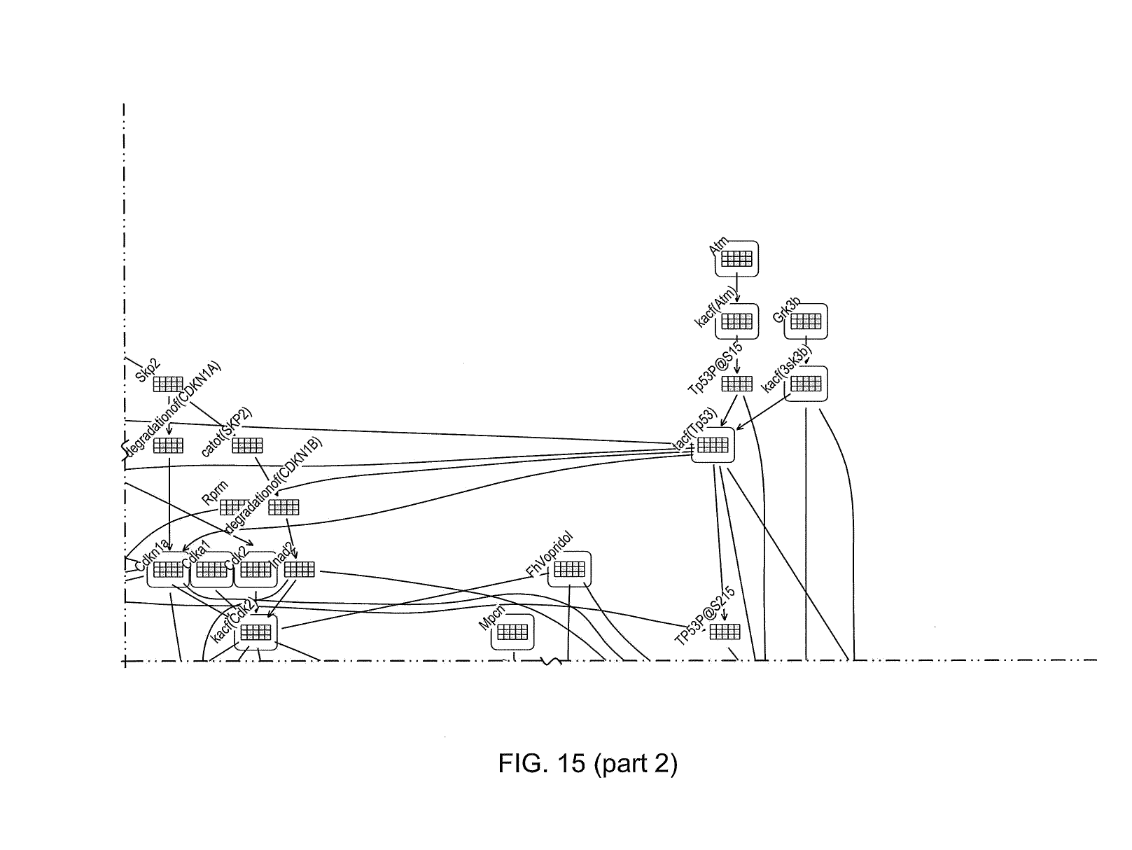

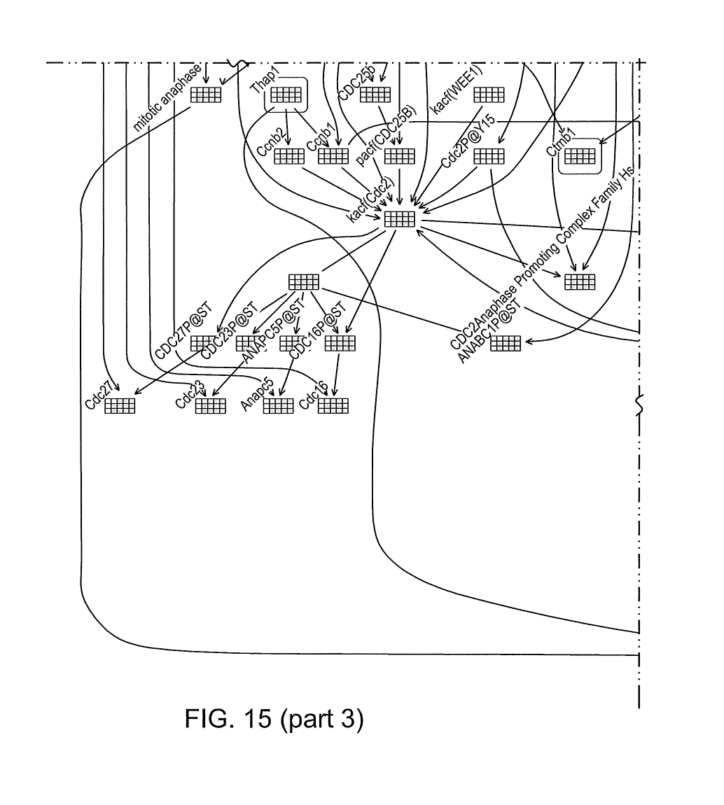

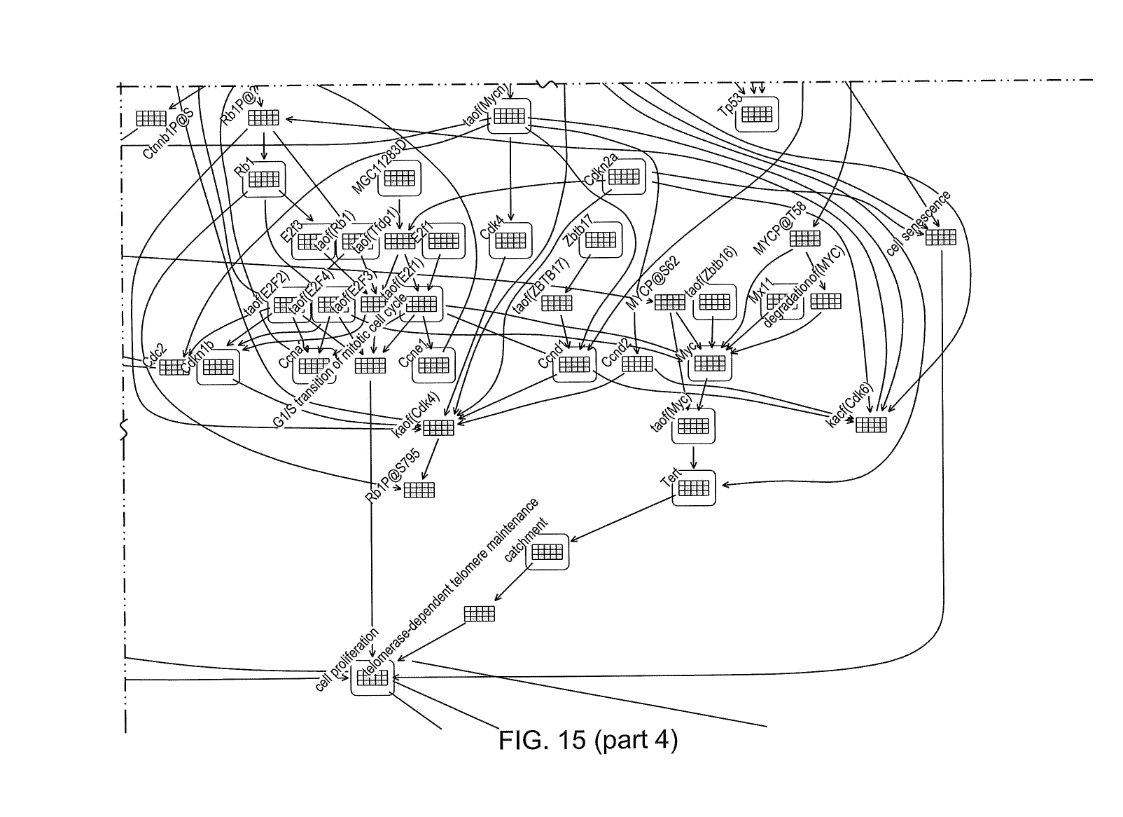

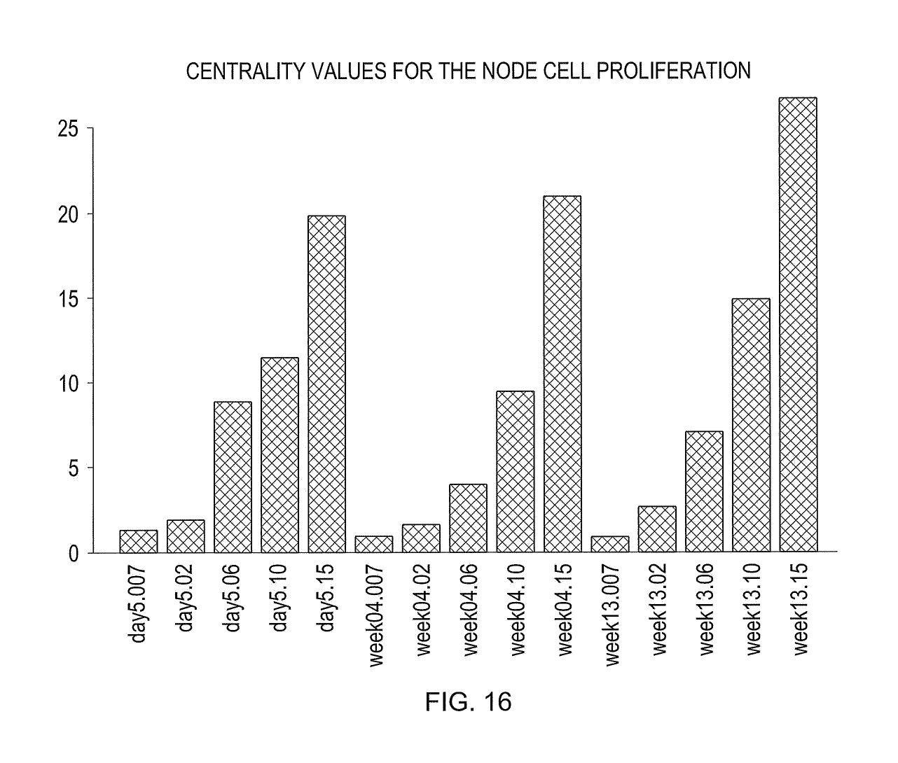

The centrality value techniques described in relation to FIGS. 5-8 have been applied to a formaldehyde exposure experiment in rats. Eight week old male F344/CrIBR rats were exposed to formaldehyde through whole body inhalation. Whole body exposures were performed at doses of 0, 0.7, 2, 6, 10, and 15 ppm (6 hours per day, 5 days per week). Animals were sacrificed at 1, 4, and 13 weeks following initiation of exposure. Following sacrifice, tissue from the Level II region of the nose was dissected and digested with a mixture of proteases to remove the epithelial cells. The epithelial cells acquired from this section of the nose consisted primarily of transitional epithelium with some respiratory epithelium. Gene expression microarray analysis was performed on the epithelial cells. To further a systems-level assessment of the biological impact of perturbations on nondiseased mammalian lung cells, a lung-focused causal network for cell proliferation was constructed by Westra et al., Construction of a Computable Cell Proliferation Network Focused on Non-Diseased Lung Cells, BMC Systems Biology 2011, 5:105 which encompasses diverse biological areas that lead to the regulation of normal lung cell proliferation (Cell Cycle, Growth Factors, Cell Interaction, Intra- and Extracellular Signaling, and Epigenetics), and contains a total of 848 nodes (biological entities) and 1597 edges (relationships between biological entities). The network was verified using four published gene expression profiling data sets associated with measured cell proliferation endpoints in lung and lung-related cell types. Predicted changes in the activity of core machinery involved in cell cycle regulation (RB1, CDKN1A, and MYC/MYCN) are statistically supported across multiple data sets, underscoring the general applicability of this approach for a network-wide biological impact assessment using systems biology data. The centrality results shown in FIG. 15 are shown in the gradation of shadings for the nodes. In particular, the results indicate that certain nodes (e.g., nodes with mostly light shading corresponding to Kaof(Akt family R n), WEE related nodes, and Cdc2 P@Y15) have negative log-centrality values, indicative of a region of the network that is not reinforced. In addition, a negatively influencing node 604 with lighter shading (corresponding to taof(E2F2)) has a negative influence on cell proliferation. In another example, FIG. 15 shows a positively influencing node (corresponding to taof(Myc)) for cell proliferation. The results shown in FIG. 15 indicate that taof(Myc) is a positive influence on regulation of the cell cycle (during a transition from phase G1 to phase S, for example). A subset of the nodes in FIG. 15 are indicative of a HYP, which is associated with a type of causal signature of measurable quantities. The name “HYP” is derived from “hypothesis”, reflective of the fact that the HYP can be considered to make a set of predictions, and the HYP may provide insight regarding a mechanism of a particular biological process. In particular, the HYP may correspond to one or more measurable entities (for example, at least some of the nodes in FIG. 15) and their direction of change (increased or decreased) in response to a perturbation. Furthermore, FIG. 16 shows an exponential dose dependent pattern in the reinforcement of cell proliferation, which is consistent with the results described in the literature. Using the techniques described herein, the perturbed regions of the network are identified and it reveals a time- and dose-dependent reinforcement, but also reveals regions with opposite signs. Thus, the structure of the overall system's response hidden in the noisy behavior of thousands of downstream-controlled genes is captured by the disclosed approach, providing a insightful way to describe global effects of external perturbations on a biological network by combining the knowledge contained in a causal model and the system's response measured by gene expression technology.

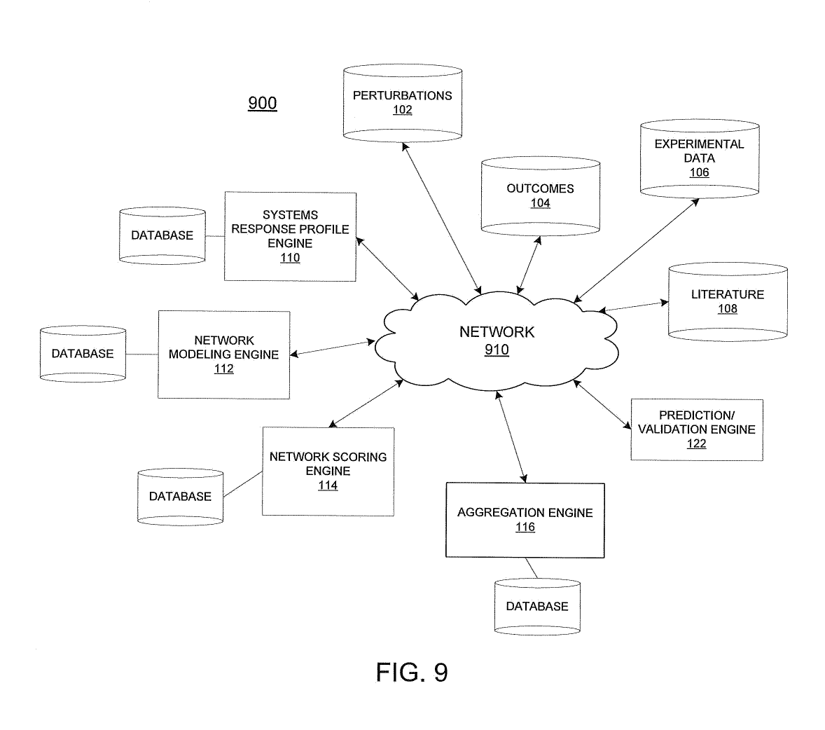

FIG. 9 is a block diagram of a distributed computerized system 900 for quantifying the impact of biological perturbations. The components of the system 900 are the same as those in the system 100 of FIG. 1, but the arrangement of the system 100 is such that each component communicates through a network interface 910. Such an implementation may be appropriate for distributed computing over multiple communication systems including wireless communication system that may share access to a common network resource, such as “cloud computing” paradigms.

FIG. 10 is a block diagram of a computing device, such as any of the components of system 100 of FIG. 1 or system 900 of FIG. 9 for performing processes described with reference to FIGS. 1-10. Each of the components of system 100, including the SRP engine 110, the network modeling engine 112, the network scoring engine 114, the aggregation engine 116 and one or more of the databases including the outcomes database, the perturbations database, and the literature database may be implemented on one or more computing devices 1000. In certain aspects, a plurality of the above-components and databases may be included within one computing device 1000. In certain implementations, a component and a database may be implemented across several computing devices 1000.

The computing device 1000 comprises at least one communications interface unit, an input/output controller 1010, system memory, and one or more data storage devices. The system memory includes at least one random access memory (RAM 1002) and at least one read-only memory (ROM 1004). All of these elements are in communication with a central processing unit (CPU 1006) to facilitate the operation of the computing device 1000. The computing device 1000 may be configured in many different ways. For example, the computing device 1000 may be a conventional standalone computer or alternatively, the functions of computing device 1000 may be distributed across multiple computer systems and architectures. The computing device 1000 may be configured to perform some or all of modeling, scoring and aggregating operations. In FIG. 10, the computing device 1000 is linked, via network or local network, to other servers or systems.

The computing device 1000 may be configured in a distributed architecture, wherein databases and processors are housed in separate units or locations. Some such units perform primary processing functions and contain at a minimum a general controller or a processor and a system memory. In such an aspect, each of these units is attached via the communications interface unit 1008 to a communications hub or port (not shown) that serves as a primary communication link with other servers, client or user computers and other related devices. The communications hub or port may have minimal processing capability itself, serving primarily as a communications router. A variety of communications protocols may be part of the system, including, but not limited to: Ethernet, SAP, SAS™, ATP, BLUETOOTH™, GSM and TCP/IP.

The CPU 1006 comprises a processor, such as one or more conventional microprocessors and one or more supplementary co-processors such as math co-processors for offloading workload from the CPU 1006. The CPU 1006 is in communication with the communications interface unit 1008 and the input/output controller 1010, through which the CPU 1006 communicates with other devices such as other servers, user terminals, or devices. The communications interface unit 1008 and the input/output controller 1010 may include multiple communication channels for simultaneous communication with, for example, other processors, servers or client terminals Devices in communication with each other need not be continually transmitting to each other. On the contrary, such devices need only transmit to each other as necessary, may actually refrain from exchanging data most of the time, and may require several steps to be performed to establish a communication link between the devices.

The CPU 1006 is also in communication with the data storage device. The data storage device may comprise an appropriate combination of magnetic, optical or semiconductor memory, and may include, for example, RAM 1002, ROM 1004, flash drive, an optical disc such as a compact disc or a hard disk or drive. The CPU 1006 and the data storage device each may be, for example, located entirely within a single computer or other computing device; or connected to each other by a communication medium, such as a USB port, serial port cable, a coaxial cable, an Ethernet type cable, a telephone line, a radio frequency transceiver or other similar wireless or wired medium or combination of the foregoing. For example, the CPU 1006 may be connected to the data storage device via the communications interface unit 1008. The CPU 1006 may be configured to perform one or more particular processing functions.

The data storage device may store, for example, (i) an operating system 1012 for the computing device 1000; (ii) one or more applications 1014 (e.g., computer program code or a computer program product) adapted to direct the CPU 1006 in accordance with the systems and methods described here, and particularly in accordance with the processes described in detail with regard to the CPU 1006; or (iii) database(s) 1016 adapted to store information that may be utilized to store information required by the program. In some aspects, the database(s) includes a database storing experimental data, and published literature models.

The operating system 1012 and applications 1014 may be stored, for example, in a compressed, an uncompiled and an encrypted format, and may include computer program code. The instructions of the program may be read into a main memory of the processor from a computer-readable medium other than the data storage device, such as from the ROM 1004 or from the RAM 1002. While execution of sequences of instructions in the program causes the CPU 1006 to perform the process steps described herein, hard-wired circuitry may be used in place of, or in combination with, software instructions for implementation of the processes of the present disclosure. Thus, the systems and methods described are not limited to any specific combination of hardware and software.

Suitable computer program code may be provided for performing one or more functions in relation to modeling, scoring and aggregating as described herein. The program also may include program elements such as an operating system 1012, a database management system and “device drivers” that allow the processor to interface with computer peripheral devices (e.g., a video display, a keyboard, a computer mouse, etc.) via the input/output controller 1010.

The term “computer-readable medium” as used herein refers to any non-transitory medium that provides or participates in providing instructions to the processor of the computing device 1000 (or any other processor of a device described herein) for execution. Such a medium may take many forms, including but not limited to, non-volatile media and volatile media. Non-volatile media include, for example, optical, magnetic, or opto-magnetic disks, or integrated circuit memory, such as flash memory. Volatile media include dynamic random access memory (DRAM), which typically constitutes the main memory. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM or EEPROM (electronically erasable programmable read-only memory), a FLASH-EEPROM, any other memory chip or cartridge, or any other non-transitory medium from which a computer can read.

Various forms of computer readable media may be involved in carrying one or more sequences of one or more instructions to the CPU 1006 (or any other processor of a device described herein) for execution. For example, the instructions may initially be borne on a magnetic disk of a remote computer (not shown). The remote computer can load the instructions into its dynamic memory and send the instructions over an Ethernet connection, cable line, or even telephone line using a modem. A communications device local to a computing device 1000 (e.g., a server) can receive the data on the respective communications line and place the data on a system bus for the processor. The system bus carries the data to main memory, from which the processor retrieves and executes the instructions. The instructions received by main memory may optionally be stored in memory either before or after execution by the processor. In addition, instructions may be received via a communication port as electrical, electromagnetic or optical signals, which are exemplary forms of wireless communications or data streams that carry various types of information.

In a further aspect, there is provided a computer system for determining metrics for nodes in a network model of a biological system, comprising a first processor configured or adapted to receive a set of treatment data corresponding to a response of a biological system to an agent, wherein the biological system includes a plurality of biological entities, each biological entity interacting with at least one other of the biological entities; at a second processor configured or adapted to receive a set of control data corresponding to the biological system not exposed to the agent; at a third processor configured or adapted to provide a computational causal network model that represents the biological system and includes: nodes representing the biological entities, edges representing relationships between the biological entities, wherein an edge connects a corresponding first node to a corresponding second node, and a fourth processor configured or adapted to calculate perturbation indices for a subset of the nodes, based at least in part on the network model, wherein a perturbation index represents a difference between the treatment data and the control data at a corresponding node and an extent to which activity of the corresponding node is impacted by the perturbation; a fifth processor configured or adapted to calculate transition probabilities, for the edges, based at least in part on the perturbation indices, wherein a transition probability for an edge represents a likelihood of transitioning from the corresponding first node to the corresponding second node; and a sixth processor configured or adapted to generate centrality values for the nodes, based at least in part on the transition probabilities, wherein a centrality value represents a relative importance of a corresponding node in the network model.

In a further aspect, there is provided a computer system comprising: a first processor configured or adapted to receive a set of first treatment data; a second processor configured or adapted to receive a set of second treatment data; a third processor configured or adapted to provide a computational causal network model including: nodes representing biological entities, and edges representing relationships between the biological entities; a fourth processor configured or adapted to calculate perturbation indices for a subset of the nodes, based at least in part on the network model, wherein a perturbation index represents a difference between the first and second treatment data at a corresponding node; a fifth processor configured or adapted to generate centrality values for corresponding nodes, based at least in part on the perturbation indices, wherein a centrality value represents a relative importance of the corresponding node in the network model; and a sixth processor configured or adapted to calculate a partial derivative of a centrality value for a first node with respect to the perturbation index for a second node, wherein the partial derivative represents a topological sensitivity measure for the network model.

In a further aspect, there is provided a computer system, comprising: a first processor configured or adapted to provide a computational network model including: nodes representing biological entities, and edges representing relationships between the biological entities; a second processor configured or adapted to generate centrality values for corresponding nodes, based at least in part on the network model, wherein a centrality value represents a relative importance of the corresponding node in the network model; and a third processor configured or adapted to calculate projections of the centrality values onto spectral transform vectors for representing effects of a perturbation on the network model.

In a further aspect, there is provided a computer system for quantifying a perturbation of a biological system, comprising: a first processor configured or adapted to provide a computational causal network model including: nodes representing biological entities, and edges representing relationships between the biological entities; a second processor configured or adapted to generate centrality values for corresponding nodes, based at least in part on the network model, wherein a centrality value represents a relative importance of the corresponding node in the network model; and a third processor configured or adapted to aggregate the centrality values to generate a score for the network model representing a perturbation of the biological system.

In a further aspect there is provided a computer program product comprising a program code adapted to perform the methods described herein.

In a further aspect, there is provided a computer or a computer recordable medium or a device comprising the computer program product.

While implementations of the disclosure have been particularly shown and described with reference to specific examples, it should be understood by those skilled in the art that various changes in form and detail may be made therein without departing from the spirit and scope of the disclosure as defined by the appended claims. The scope of the disclosure is thus indicated by the appended claims and all changes which come within the meaning and range of equivalency of the claims are therefore intended to be embraced. All publications mentioned in the above specification are herein incorporated by reference.

1. A computerized method for determining metrics for nodes in a network model of a biological system, comprising
receiving, at a first processor, a set of treatment data corresponding to a response of a biological system to an agent, wherein the biological system includes a plurality of biological entities, each biological entity interacting with at least one other of the biological entities;
receiving, at a second processor, a set of control data corresponding to the biological system not exposed to the agent;
providing, at a third processor, a computational causal network model that represents the biological system and includes:
nodes representing the biological entities,
edges representing relationships between the biological entities, wherein an edge connects a corresponding first node to a corresponding second node, and
calculating, with a fourth processor, perturbation indices for a subset of the nodes, based at least in part on the network model, wherein a perturbation index represents a difference between the treatment data and the control data at a corresponding node and an extent to which activity of the corresponding node is impacted by the perturbation;
calculating, with a fifth processor, transition probabilities, for the edges, based at least in part on the perturbation indices, wherein a transition probability for an edge represents a likelihood of transitioning from the corresponding first node to the corresponding second node; and
generating, with a sixth processor, centrality values for the nodes, based at least in part on the transition probabilities, wherein a centrality value represents a relative importance of a corresponding node in the network model.

2. The computerized method of claim 1, wherein the perturbation index is a linear combination of activity measures of nodes downstream from the corresponding node.

3. The computerized method of claim 1, wherein the transition probability for an edge is a linear function of the perturbation index of the second node.

4. The computerized method of claim 1, further comprising calculating, with a seventh processor, equilibrium probabilities for the nodes representative of probabilities of a random walk visiting the nodes in the steady state.

5. The computerized method of claim 1, wherein the sixth processor generates the centrality values based at least in part on the equilibrium probabilities.

6. The computerized method of claim 1, wherein the sixth processor generates the centrality value for a corresponding node based at least in part on a number of expected visits of a random walk to the corresponding node between consecutive visits to other nodes.

7. The computerized method of claim 1, wherein the perturbation index is further based on a fold-change value representing a difference between the treatment data and the control data at the corresponding node.

8. A computerized method, comprising:
receiving, at a first processor, a set of first treatment data;
receiving, at a second processor, a set of second treatment data;
providing, at a third processor, a computational causal network model including:
nodes representing biological entities, and
edges representing relationships between the biological entities;
calculating, with a fourth processor, perturbation indices for a subset of the nodes, based at least in part on the network model, wherein a perturbation index represents a difference between the first and second treatment data at a corresponding node;
generating, with a fifth processor, centrality values for corresponding nodes, based at least in part on the perturbation indices, wherein a centrality value represents a relative importance of the corresponding node in the network model; and
calculating, with a sixth processor, a partial derivative of a centrality value for a first node with respect to the perturbation index for a second node, wherein the partial derivative represents a topological sensitivity measure for the network model.

9. The computerized method of claim 8, wherein calculating the partial derivative includes determining an effect of a change in the perturbation index of the second node on a change in the centrality value of the first node.

10. A computerized method, comprising:
providing, at a first processor, a computational network model including:
nodes representing biological entities, and
edges representing relationships between the biological entities;
generating, with a second processor, centrality values for corresponding nodes, based at least in part on the network model, wherein a centrality value represents a relative importance of the corresponding node in the network model;
calculating, with a third processor, projections of the centrality values onto spectral transform vectors for representing effects of a perturbation on the network model.

11. The computerized method of claim 10, wherein calculating projections of the centrality values includes filtering the centrality values.

12. A computerized method for quantifying a perturbation of a biological system, comprising:
providing, at a first processor, a computational causal network model including:
nodes representing biological entities, and
edges representing relationships between the biological entities;
generating, with a second processor, centrality values for corresponding nodes, based at least in part on the network model, wherein a centrality value represents a relative importance of the corresponding node in the network model; and
aggregating, by a third processor, the centrality values to generate a score for the network model representing a perturbation of the biological system.

13. The computerized method of claim 12, wherein the score is a scalar value.

14. The computerized method of claim 12, wherein aggregating the centrality values includes computing a linear combination of the centrality values.

15. The computerized method of claim 12, wherein aggregating the centrality values includes computing a linear combination of spectral transforms of the centrality values.
